(19) United States
(12) Patent Application Publication
(10) Pub. No.: US 2024/0260528 A1
(43) Pub. Date: Aug. 8, 2024

(54) METHODS AND APPARATUSES FOR GROWING MARINE PLANTS AND MACROALGAE AND AN APPARATUS FOR SEEDING CULTIVATING AND HARVESTING MARINE PLANTS AND MACROALGAE

(71) Applicant: CLIMATE FOUNDATION, Seattle, WA (US)

(72) Inventors: Brian von HERZEN, Carson City, NV (US); Paul COTEUS, Seattle, WA (US)

(73) Assignee: CLIMATE FOUNDATION, Seattle, WA (US)

(21) Appl. No.: 18/562,820

(22) PCT Filed: May 20, 2022
(86) PCT No.: PCT/US22/30404

§ 371 Date: Nov. 20, 2023

Related U.S. Application Data
(60) Provisional application No. 63/191,798, filed on May 21, 2021.

(51) Int. Cl. A01G 33/00

(52) U.S. Cl. CPC A01G 33/00

(57) ABSTRACT

Disclosed are a system and method for growing aquatic plants or macroalgae at variable depths in a body of water. The system includes floating upper ring, a submerged lower ring, and one or more cables, ropes, or chains connecting the lower ring to the upper ring. Also disclosed are a self-powered apparatus and a method of growing aquatic plants or macroalgae with depth cycling. The apparatus include a platform, a floating support, one or more winches for a corresponding cable, ropes, or chain, one or more motors configured to operate the one or more winches, and a renewable power source on or by the platform that provides electrical power to each motor.

### CROSS REFERENCE TO RELATED APPLICATION

This application claims the benefit of U.S. Provisional Patent Application No. 63/191,798, filed on May 21, 2021, and incorporated herein by reference as if fully set forth herein.

### FIELD OF THE INVENTION

The present invention relates to apparatuses for and methods of growing aquatic plants and macroalgae, such as seaweed and kelp, in a large and/or natural body of water.

### DISCUSSION OF THE BACKGROUND

U.S. Pat. No. 7,905,055 discloses an automated ocean farm that includes a plant support means such as a grid, with a submersible towing system incorporating means for navigation of the support grid in the open ocean, and means for positioning of the support grid in a first surfaced position for sunlight exposure of the plants and a second submerged position for nutrient gathering by the plants. Referring to FIG. 1, a farm 10 according to the '055 patent includes strong neutral-buoyancy rope 12 with two similar ropes 14 trailing back with additional neutral buoyancy ropes 16 stretched between them to create a support grid. The support grid may be supported by buoys at spaced intervals to provide a substantially neutrally buoyant grid. Marine plants 18 are anchored to the grid at periodic intervals (e.g. 1 meter spacing along the ropes for California Giant Kelp with 10-meter down-current spacing to accommodate the plants at harvestable size and 0.2 to 0.4 m for tropical seaweeds such as Eucheuma spp and Kappaphycus spp.). The grid is propelled by a submersible towing system. Two towing boats 20 and 22 provide a first element of the towing system. Two reaction boats 24 and 26 provide a second element of the towing system to create and maintain tension in the lines by relative positioning with respect to the two tow boats.

FIG. 2 shows tow and reaction boats having a controlled submersion system on the plant support grid with associated extendible supports from the boats according to the '055 patent. The tow boat 102 and reaction boat 104 each employ a winch 106 and cable 108 which are attached to the plant support grid 110. Buoys 112 incorporate ballast tanks 114 to maintain the desired buoyancy of the support grid for submerging to the nutrient rich layers. Computer controlled valves 116 for flooding the ballast tanks to submerge and compressed air lines 118 from a pressurization source on one or more of the boats provide for expelling water from the ballast tanks to surface. Sensors 120 on the grid provide communications of layer composition to computer 122 for ballast control.

This “Discussion of the Background” section is provided for background information only. The statements in this “Discussion of the Background” are not an admission that the subject matter disclosed in this “Discussion of the Background” section constitutes anticipatory prior art to the present disclosure, and no part of this “Discussion of the Background” section may be used as an admission that any part of this application, including this “Discussion of the Background” section, constitutes prior art to the present disclosure.

### SUMMARY OF THE INVENTION

In one aspect, the present invention concerns an apparatus for growing aquatic plants or macroalgae at variable depths, comprising an upper or floating ring, a lower or submerged ring, and one or more cables, ropes or chains connecting the lower ring to the upper ring. The upper ring comprises (i) a material having a density less than that of water or (ii) an air-filled ring, bladder, buoy or vessel adapted to float on a surface of a body of water. The lower ring has or is ballasted to have a density greater than that of fresh or sea water. Each of the upper ring and the lower ring comprises a material on its outermost surface that resists damage by water. The lower ring may further comprise a support to which the aquatic plants or macroalgae can be secured or on which the aquatic plants or macroalgae can be grown. The support may comprise a plurality of parallel lines or wires, a plurality of radially-distributed lines or wires, or a mesh or grid.

In various embodiments, each of the upper and lower rings independently has a circular, toroidal, oval, square, rectangular, triangular or other regular geometric shape, and may have either (i) a width and length or (ii) a diameter of from 10 m to 1200 m. In some embodiments, each of the upper and lower rings independently comprises polyethylene or polypropylene, and may have a tube or pipe diameter of 0.05-5.00 m. In various embodiments, each cable or ropes or chain comprises e.g. polyethylene, polypropylene, carbon fiber composite or steel, and may have a length of from 50 m to 3000 m.

In many embodiments, the apparatus further comprises one or more winches on the upper ring. Each winch is configured to raise and lower a corresponding cable or ropes or chain, and may be motorized (e.g., the apparatus further comprises a motor configured to operate the corresponding winch) or manually operated (e.g., the winch further comprises an arm attached to a rotatable axle of shaft, and a handle attached to the arm). In some embodiments, the lower ring may comprise one or more negative lift hydrofoils.

Another aspect of the present invention concerns a self-powered apparatus for growing aquatic plants or macroalgae with depth cycling, comprising a platform, a floating support to which the platform is affixed, one or more winches on the platform, one or more motors on the platform, and a green or renewable power source on or supported by the platform. The floating support is configured to physically support the platform on a body of water. A corresponding cable or ropes or chain is attached to each winch. The motor(s) are configured to operate the winch(es). The power source provides electrical power directly or indirectly to the motor(s).

In some embodiments, the apparatus further comprises a battery and an optional power controller. The battery stores the electrical power from the renewable power source. The power controller is configured to provide the electrical power (i) from the renewable power source to the battery and (ii) from the battery to the motor(s).

In other or further embodiments, the apparatus may further comprise a controller configured to (i) control the motor(s), to raise or lower the cable or ropes or chain attached to the corresponding winch by predetermined amounts and/or at predetermined times, and (ii) control the power controller to provide the electrical energy from the battery to the motor(s) when the renewable power source is not producing electricity. The apparatus may also further comprise (i) a light sensor configured to provide light data to the controller for comparison with one or more predetermined thresholds (e.g., corresponding to an amount or intensity of light associated with a sunrise and/or a sunset), (ii) a weather sensor configured to provide weather data to the controller (e.g., for comparison with one or more thresholds corresponding to a weather event that might make it dangerous to bring the aquatic plants or macroalgae to the surface), and/or (iii) a temperature sensor configured to provide a temperature of the water at the lower ring, (iv) a current meter that can measure a velocity of the water at either of the rings, (v) a motion sensor configured to determine a distance that or a rate at which the upper or floating ring moves (e.g., for comparison with one or more thresholds corresponding to a rough sea, which could cause damage to the apparatus or the aquatic plants or macroalgae if brought to the surface), or (vi) a depth and/or pressure sensor for measuring the depth of the upper or lower ring. In various embodiments, the apparatus comprises the light sensor and/or the weather sensor. The weather sensor can be selected from a temperature sensor, a precipitation sensor, and a wind sensor.

Yet another aspect of the present invention concerns a controller for growing aquatic plants or macroalgae with depth cycling, comprising a processor or core configured to send instructions to other components and/or circuit blocks in the controller over an internal bus, a memory configured to receive, record, store and/or provide data, programming and/or the instructions, power control circuitry configured to receive power from an external source and provide power to the other components and/or circuit blocks over power supply lines, a receiver and/or a transmitter, and function logic configured to operate one or more motors to raise or lower one or more cables or ropes or chains on a corresponding one or more winches (e.g., operably connected to the motor) by one or more (pre)determined amounts at one or more (pre)determined times. The receiver is configured to receive external signals, and the transmitter is configured to transmit internal information (e.g., from the memory and/or the processor or core to an external device). Thus, many embodiments of the controller further comprise (i) a timer configured to provide a timing signal to the other components and/or circuit blocks and/or (ii) an antenna configured to receive the wireless signals from an external source (e.g., a computer or other digital processing device configured to program the controller) and/or broadcast the internal information to one or more external devices.

In some embodiments, the controller may further comprise (i) a weather detection block configured to receive weather data from a weather sensor and (ii) a motion detection block configured to receive motion data from a motion sensor. The weather sensor may include a temperature sensor, a light sensor, a precipitation sensor, or a wind sensor. The controller may be adapted for use with the apparatus described above or a method of growing seaweed and/or aquatic plants with depth cycling (see below).

Still another aspect of the present invention concerns a method of growing seaweed and/or aquatic plants, comprising determining whether an ambient or environmental light exceeds a first predetermined threshold amount or intensity of light, raising the seaweed and/or the aquatic plants from a first (e.g., lowermost) depth in a body of water to a second, shallower depth in the body of water when the ambient or environmental light exceeds the first predetermined threshold amount or intensity of light, determining whether the ambient or environmental light decreases below a second predetermined threshold amount or intensity of light, and lowering the seaweed and/or the aquatic plants to the first depth when the ambient or environmental light decreases below the second predetermined threshold amount or intensity of light. The second depth depends on whether any conditions are met that would be dangerous for the seaweed and/or the aquatic plants to come to a surface of the body of water. The first predetermined threshold amount or intensity of light may correspond to a sunrise, and the second predetermined threshold amount or intensity of light may correspond to a sunset. The body of water may be a lake, bay, inlet, river, gulf, sea or ocean. The present method is useful for implementing depth cycling when growing seaweed and/or aquatic plants, where the seaweed and/or aquatic plants is brought to the surface during daytime, and taken to a depth where the water is cooler and more nutrient-rich during nighttime.

In general, when no conditions are met that would be dangerous for the seaweed and/or the aquatic plants to come to the surface of the body of water, the second depth is an upper or uppermost position, and when one or more conditions are met that would be dangerous for the seaweed and/or the aquatic plants to come to the surface of the body of water, the second depth is an intermediate position. The intermediate position is lower/deeper than the upper or uppermost position. For example, the first (lowermost) depth may be 100-1000 m, the intermediate position may be 25-100 m, and the upper or uppermost position may be 0.1-25 m.

The method may further comprise determining whether one or more conditions are met that would be dangerous for the seaweed and/or the aquatic plants to come to the surface of the body of water. The conditions may include one or more of rough seas, bad weather, and navigation hazards.

In many embodiments, the seaweed and/or the aquatic plants are on or affixed to a ring, and the ring is attached to one or more cables or ropes or chains. In such embodiments, raising the seaweed and/or the aquatic plants may comprise taking in or winding the cable(s) or ropes or chain(s), and lowering the seaweed and/or the aquatic plants may comprise letting out or releasing the cable(s) or ropes or chain(s).

Yet another aspect of the present invention concerns a second apparatus for growing seaweed or aquatic plant(s), comprising a bow pipe, a stern pipe, a plurality of ribs, and one or more nets on or fixed to the ribs. The net(s) may have different mesh sizes, depending on the seaweed species. Each of the ribs is connected to each of the bow pipe (e.g., at a first end of the rib) and the stern pipe (e.g., at a second, opposite end of the rib). Each net is substantially submerged in the water, and forms a volume or space in which the seaweed or aquatic plant(s) grow.

In some embodiments, each of the bow pipe, the plurality of ribs, and the stern pipe may comprise a hollow polyethylene/polypropylene pipe. Each of the bow pipe, the plurality of ribs, and the stern pipe may have a length of at least 10 m (e.g., 10-100 m or more).

The second apparatus may further comprise first ballast in or attached to at least one net and/or second ballast on or attached to at least one of the bow pipe and the stern pipe. The first ballast is relatively small, and is adapted to keep the net in the water and/or to ensure that there is some space or volume in the net (e.g., between adjacent ribs). The second ballast is relatively large, and is adapted to facilitate lowering, sinking or submerging at least one end of the apparatus in the body of water.

In some embodiments, the apparatus may further comprise a pump configured to transfer water into and/or out of at least one of the bow pipe, the ribs, and the stern pipe. In other or further embodiments, the apparatus may further comprise an upper net on the ribs, configured to retain the seaweed or aquatic plant(s) in the space or volume. In yet other and/or further embodiments, the apparatus may further comprise (i) one or more ropes connected to at least one of the bow pipe, the plurality of ribs, and the stern pipe, (ii) a corresponding one or more winches configured to pull in or let out one or more ropes, and (iii) a corresponding one or more motors configured to operate the one or more winches. In this and the other aspects of the present invention, the winch(es), the motor(s) and the rope(s) (or the cable[s] or ropes or chain[s]) may be in a 1:1:1 relationship.

A still further aspect of the present invention concerns a method of growing and harvesting aquatic plants or seaweed, comprising seeding the aquatic plants or seaweed in one or more nets on a plurality of ribs, submerging the one or more nets and the seaweed or aquatic plants in a body of water, growing the seaweed or aquatic plants to partially or substantially fill the volume or space, and harvesting the seaweed or aquatic plants from the net(s). Each of the ribs is connected to a bow pipe and a stern pipe. The net(s) form a volume or space (e.g., between adjacent ribs) in which the seaweed or aquatic plants grow. The seaweed or aquatic plants may be grown to fill at least half of the volume or space in the net, although the invention is not limited in such a manner. The seaweed or aquatic plants are harvested using an aquatic vehicle adapted to travel over the net(s), the ribs, and at least one of the bow pipe and the stern pipe.

Yet another aspect of the present invention concerns an aquatic vehicle adapted to seed and harvest aquatic plants or macroalgae in a floating (and optionally submersible) net on or fixed to a plurality of ribs, comprising a vessel spanning two or more of the ribs, and a plurality of float segments on each of a port side and a starboard side of the vessel. Each of the ribs connected to a bow pipe and a stern pipe, and the net forms a volume or space between adjacent ribs for the seaweed or aquatic plants. Each of the float segments can be raised and lowered so as to pass over at least one of the bow pipe and the stern pipe, and optionally to pass through the space between adjacent ribs. The spaces in which each set of float segments (on opposite sides of the vessel) may be separated by 2-5 ribs.

In some embodiments, the aquatic vehicle comprises a multi-hulled vessel, such as a catamaran with a deck. The deck may have a seaweed access area thereon or therethrough. The catamaran may be 3-20 m wide and 3-20 m long. The deck may be 3-20 m wide and 1.5-10 m long. In other or further embodiments, the aquatic vehicle may comprise at least three float segments on each of the port and starboard sides.

In some embodiments, the aquatic vehicle may further comprise at least one retractable float piston connected to each of the float segments. The retractable float pistons raise the corresponding float segment over the bow pipe and/or the stern pipe, and lower the corresponding float segment back onto the water after the float segment traverses/crosses the bow/stern pipe. The aquatic vehicle may be adapted for use with the second apparatus or the method of growing and harvesting described above.

### BRIEF DESCRIPTION OF THE DRAWINGS

FIGS. 1 and 2 are diagrams showing an example farm and an example submersion system according to U.S. Pat. No. 7,905,055.

FIG. 3 is a diagram of an exemplary apparatus for growing aquatic plants, in accordance with one or more embodiments of the present invention.

FIG. 4 is a diagram showing an exemplary negative lift hydrofoil, in accordance with one or more embodiments of the present invention.

FIG. 5 is a diagram showing the exemplary apparatus of FIG. 3, partially submerged in a large and/or natural body of water, in accordance with embodiments of the present invention.

FIGS. 6A-C are diagrams showing various examples of aquatic plant supports, in accordance with embodiments of the present invention

FIG. 7 is a diagram showing an exemplary general apparatus for growing aquatic plants at a controllable depth in a large and/or natural body of water, in accordance with embodiments of the present invention.

FIG. 8 is a diagram showing an exemplary automated platform for use with the apparatus of FIG. 5, in accordance with one or more embodiments of the present invention.

FIG. 9 is a diagram showing an exemplary power and control system for use with the apparatus of FIG. 8, in accordance with one or more embodiments of the present invention.

FIG. 10 is a block diagram of an exemplary controller for use with the power and control system of FIG. 9, in accordance with one or more embodiments of the present invention.

FIG. 11 is a flow diagram of an exemplary method carried out by the apparatus of FIG. 8, in accordance with one or more embodiments of the present invention.

FIGS. 12A-B are diagrams showing front and side views of a manually-operated winch for use with the apparatus of FIG. 7, in accordance with one or more embodiments of the present invention.

FIG. 13 is a diagram showing an exemplary alternative general apparatus for growing aquatic plants at a controllable depth in a large and/or natural body of water, in accordance with embodiments of the present invention.

FIG. 14 shows another exemplary apparatus for growing aquatic plants and macroalgae at a controllable depth in a large and/or natural body of water, in accordance with embodiments of the present invention.

FIGS. 15A-B show another exemplary apparatus for growing aquatic plants and macroalgae at a controllable depth in a large and/or natural body of water, in accordance with embodiments of the present invention.

FIG. 16 shows an exemplary frame or support for use with the apparatus of FIGS. 15A-B, in accordance with one or more embodiments of the present invention.

FIG. 17 is a diagram showing a top view of one or more embodiments of the present invention, including a support structure for a floating array of marine plants or macroalgae, on the ocean surface.

FIGS. 18A-B is a diagram showing an exemplary support structure deployed horizontally, with a net thereon in accordance with one or more embodiments of the present invention.

FIG. 19 is a diagram showing an exemplary array oriented vertically in a large and/or natural body of water, lowered by uncoiling ropes from the bow pipe in accordance with one or more embodiments of the present invention.

FIGS. 20A-B are descriptions of Kappaphycus, a red seaweed.

FIGS. 21A-C is a diagram showing an exemplary seeding/harvesting vessel with two sectioned, retractable floats, in accordance with one or more embodiments of the present invention.

FIG. 22 is a chart of HDPE rope properties.

FIG. 23A shows an exemplary motor for a winch in accordance with one or more embodiments of the present invention, FIG. 23B is a chart of specifications for an exemplary winch motor in accordance with one or more embodiments of the present invention, and FIG. 23C is a diagram showing an end view of a pump between two bow pipes, on a bounding box in accordance with one or more embodiments of the present invention.

FIG. 24 is a chart showing power requirements for exemplary motors for a winch and a pump, in accordance with one or more embodiments of the present invention.

FIG. 25 is a diagram showing a top view of an exemplary raft/array floating on the water surface, in accordance with one or more alternative embodiments of the present invention.

FIG. 26 shows an exemplary propeller and a description thereof, in accordance with one or more embodiments of the present invention.

FIG. 27 is a chart showing properties for determining an optimal propeller and motor therefor, in accordance with one or more embodiments of the present invention.

FIG. 28 shows a front view of a section of a bow pipe of a raft, with 6 take-up reels thereon.

FIG. 29 is a top view of a horizontally-disposed array, floating on the ocean surface in accordance with one or more embodiments of the present invention.

FIGS. 30A-B show closeups of the bow section of FIG. 29.

FIG. 31A is a front view and FIG. 31B is a side view of an exemplary raft with a seaweed array vertically hanging from the floating bow section, in accordance with one or more embodiments of the present invention.

FIG. 32 shows side or edge views of exemplary arrays, positioned horizontally at the surface of the water, in accordance with one or more embodiments of the present invention.

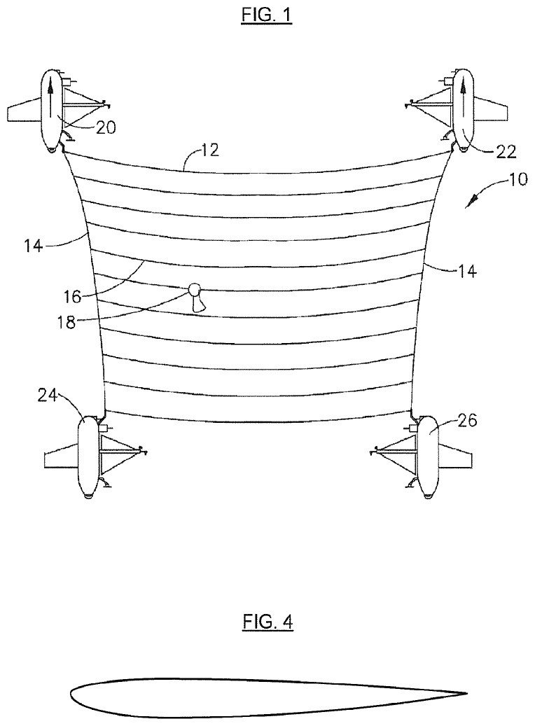

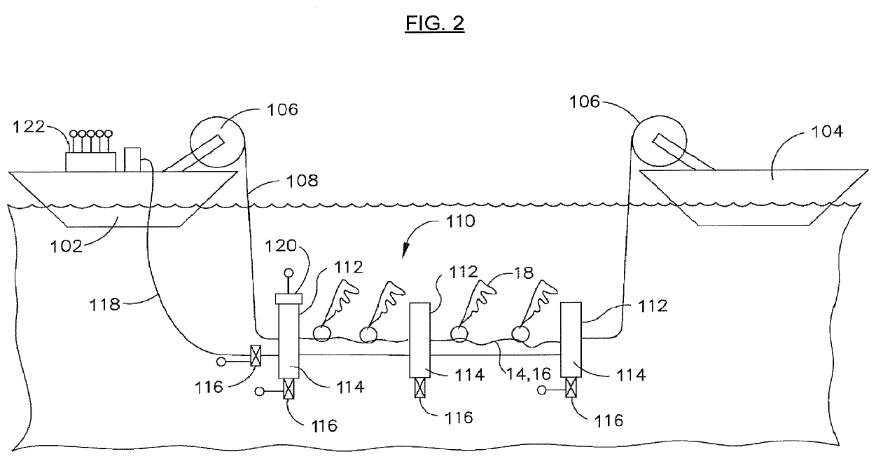

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

For the sake of convenience and simplicity, the terms “tube,” “hose,” “conduit,” “pipe” and grammatical variations thereof are, in general, interchangeable and may be used interchangeably herein, but are generally given their art-recognized meanings. Wherever one such term is used, it also encompasses the other terms. Similarly, for convenience and simplicity, the terms “rope,” “line,” and “cable” may be used interchangeably herein. Wherever one such term is used, it also encompasses the other terms.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

### Exemplary Apparatuses, Structures and Methods for Growing Aquatic Plants or Macroalgae at Variable Depths

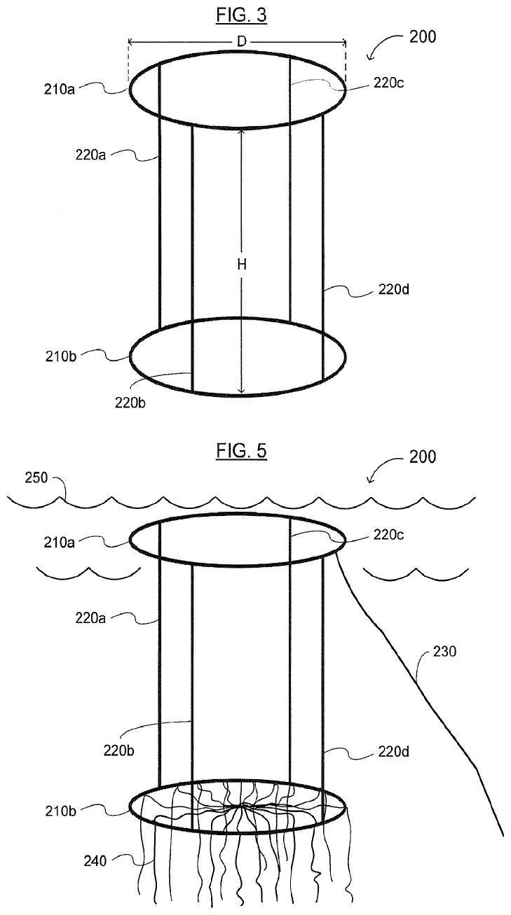

FIG. 3 shows an exemplary apparatus/structure 200 for growing macroalgae and other aquatic plants on a relatively large scale. Herein, the term “aquatic plant” refers to and includes any organisms included in or under the kingdom Plantae, including those that live primarily or exclusively in water. In its simplest form, the apparatus/structure 200 comprises an upper (or floating) ring 210a, a lower (or submerged) ring 210b, and four cables or ropes or chains 220a-d. The upper or floating ring 210a may comprise a material having a density less than that of fresh or sea water (e.g., <1.00-1.03 kg/liter). For example, the upper or floating ring 210a may comprise wood, bamboo and/or an organic polymeric material such as polyethylene, polypropylene, latex or rubber, or a mixture or blend thereof. Alternatively, the upper or floating ring 210a may comprise an air-filled ring, bladder, buoy or vessel adapted to float on the surface of a body of water. The lower or submerged ring 210b may comprise a material having a density greater than that of fresh or sea water (e.g., >1.0-1.03 kg/liter). When the lower or submerged ring 210b has a density near or less than that of water (e.g., <1.03 kg/liter), weights or ballast having a density >1.03 kg/liter may be added, attached or affixed to the lower or submerged ring 210b to increase the overall density of the lower or submerged ring 210b beyond that of the surrounding body of water and ensure that it stays submerged in the water.

Both the upper and lower rings 210a-b should comprise a material that resists damage by water as or on its outermost surface. As shown in FIG. 3, the upper and lower rings 210a-b have a circular or toroidal shape, although they may also independently have a different shape, such as oval, square, rectangular, triangular or other regular or irregular polygonal and/or curved shape.

When designed for large-scale aquatic mariculture, the upper and lower rings 210a-b may independently have (i) a width and length or (ii) a diameter of from 50 m to 1200 m, or any value or range of values therein (e.g., 100-300 m), although the invention is not limited to such values. For example, in smaller-scale aquatic mariculture, the width and length or diameter of the upper and lower rings 210a-b may be on the order of 10-100 m, although the invention is not limited to these values, either. Smaller platforms may benefit from having a single rope, line or cable over part or all of the distance between the upper and lower rings, to avoid the prospect of tangling the cable or ropes or chain over the full deployment depth.

The outer tube diameter of the upper and lower rings 210a-b may be in the range of 0.05-10 m, inclusive, depending on the width and length or diameter of the upper and lower rings 210a-b and the material of the rings 210a-b. When the upper and lower rings 210a-b are in the form of a tube or pipe, the tube or pipe may have a hollow interior or be solid. For example, when the upper and lower rings 210a-b have width and length or diameter of 10-50 m, the diameter of the upper and lower rings 210a-b may independently be 0.30-1.50 m, or any value or range of values therein, although the invention is not limited to such values. Similarly, when the upper and lower rings 210a-b have a width and a length (or a diameter) of 100-500 m, the thickness of the upper and lower rings 210a-b may independently be 0.35-5.00 m, or any value or range of values therein, although the invention is not limited to these values, either. Depending on the material, a pipe diameter (thickness) above a certain value may not provide much additional rigidity. For example, high-density polyethylene (HDPE) and polypropylene rings having a thickness of 0.3-0.6 m can withstand ocean conditions including 10- to 12-m waves and wind speeds of up to 200 km/h. As a result, there may not be much additional benefit from using HDPE or polypropylene having a diameter of more than 3 m.

In some embodiments, the lower or submerged ring 210b may comprise a negative lift hydrofoil. In other words, at least some parts of the lower or submerged ring 210b may have a cross-sectional shape configured to provide negative lift in the presence of a current in the water. In such embodiments, the negative lift can help anchor the apparatus 200 in place, or at least reduce its movement, in the presence of a current (such as can arise during relatively high winds or a storm). For example, the cross-sectional shape of a negative lift hydrofoil may resemble a cross-section of an inverted or upside-down airplane wing, as shown in FIG. 4. For example, the lower or submerged ring 210b may have three or more equally-spaced sections with a negative lift hydrofoil profile. Each such section may occupy from 3° to 30° of the ring, depending on the number of such sections. Alternatively, the entire lower or submerged ring 210b may have the negative lift hydrofoil profile. While the U.S. Dept. of Energy ARPA-E SHARKS program envisions using such negative-lift hydrofoils in the direct production of energy, this invention utilizes this available power for propulsion (e.g., to enable navigation, guidance and propulsion on timescales relevant for maricultural applications).

Although four cables or ropes or chains 220a-d are shown in FIG. 3, the apparatus/structure 200 may have a different number of cables or ropes or chains. For example, the apparatus/structure 200 may have 2, 3, 5, 6 or more cables or ropes or chains 220. Each of the cables or ropes or chains 220a-d may comprise a rope of one or more natural or synthetic polymers, a cable or line of steel or other metal or alloy, a tube or conduit, or a combination thereof. For example, ropes of polyethylene (e.g., high-density polyethylene, or HDPE) or having a polyethylene coating or similar polymer outer layer may have a “self-lubricating” function when used in conjunction with (e.g., when coming into contact with) other structures made of polyethylene or having a polyethylene coating or outer layer, such as the upper ring 210a. The tube or conduit, when present in the cable or ropes or chain 220, may be configured to upwell or downwell water from one end of the tube or conduit to the other (see, e.g., U.S. Prov. Pat. Appl. No. 62/969,031, filed Feb. 1, 2020, or International Pat. Appl. No. PCT/US2021/16020, filed Feb. 1, 2021, the relevant portions of each of which are incorporated herein by reference).

The cables or ropes or chains 220a-d may be independently secured to the upper and/or lower ring 210a-b by looping them around the ring and tying, fastening an end of the cable or ropes or chain to itself with a clamp or similar fastening device, or soldering/fusing the end of the cable or ropes or chain to itself. For example, polyethylene (PE) ropes may form an “eye” through which the upper and/or lower ring 210a-b may be fed, and the end of each polyethylene rope may be secured to itself with a metal crimp. Similarly, a rope made of natural materials can form an eye with a PE overmolding in the eye region, to take advantage of PE's “self-lubricating” properties. Alternatively, the cables or ropes or chains 220a-d may be secured to the upper and/or lower ring 210a-b by passing the end of the cable or ropes or chain through a hole or other opening in the ring and forming a knot having a size larger than the opening, or by securing it to an object such as a plate or bar having at least one diameter greater than that of the opening. In a further alternative, the rings 210a-b may be fitted with fastening rings to which the cables or ropes or chains are secured. For example, the material of the ring 210a or 210b may be passed through used automobile, motorcycle or truck tires, then the ends of the ring material may be soldered or fused to each other, and the cables or ropes or chains 220a-d secured to the tires. Other round, ring-shaped materials can also be used to secure the cables or ropes or chains 220a-d to the upper and lower rings 210a-b.

Referring now to FIGS. 3 and 5, the apparatus/structure 200 may have an aspect ratio of from 0.1 to 10 or more. Herein, an “aspect ratio” refers to the ratio of the height H of the apparatus 200 to the diameter or width D of the apparatus 200 (or, in some cases, the upper ring 210a). Thus, length of the cables or ropes or chains 220a-d may be from 50 m to 3000 m, although the actual height H of the apparatus 200 may depend on the width D of the apparatus 200 or the diameter or width of the upper ring 210a. For example, when the upper and lower rings 210a-b have width and length or diameter of 10-50 m, the aspect ratio of the apparatus 200 may be from 1.0 to 10, or any value or range of values therein, although the invention is not limited to such values. Similarly, when the upper and lower rings 210a-b have width and length or diameter of 100-300 m, the aspect ratio of the apparatus 200 may be from 0.5 to 5.0, or any value or range of values therein, and when the upper and lower rings 210a-b have width and length or diameter of 50-1200 m, the aspect ratio of the apparatus 200 may be from 0.3 to 3.0, or any value or range of values therein, although the invention is not limited to these values, either. Thus, the rings 210a-b may have a width or diameter D that is greater than the height H of the apparatus 200 or the length of the cables or ropes or chains 220a-d.

FIG. 5 shows the exemplary apparatus 200 partially submerged in a large, natural body of water 250, such as a sea or ocean, at a location where the depth of the body of water 250 is at least 100 m. The upper ring 210a is floating at the surface of the body of water 250, and the lower ring 210b has aquatic plants 240 growing thereon. The aquatic plants 240 may include one or more species or varieties of seaweed (e.g., Sargassum, such as Sargassum fusiforme; Eucheuma, such as Eucheuma cottonii or Eucheuma denticulatum, for production of carrageenan or food; Kappaphycus alvarezii; Gracilaria, particularly those species used for production of agar or ogonori; Saccharina, such as Saccharina latissima and Saccharina japonica; Undaria pinnatifida; Pyropia, particularly those species used for production of nori; Betaphycus gelatinae; Caulerpa lentillifera, for production of sea grapes; Chondrus crispus [Irish moss]; and other kelp [e.g., of the orders Laminariales and Fucales], such as giant kelp [Macrocystis pyrifera] and giant brown kelp [Ecklonia maxima], which along with certain Sargassum species, can be used as a carbon sink for carbon credits).

The lower ring 210b is at a depth of x*H, where x has a value of <1. The value of x depends on various factors, such as the current at depth H, the mass and/or density of the lower ring 210b, any twisting of the cables or ropes or chains 220a-d, etc. The apparatus 200 may be tethered or anchored in place using a cable, rope or chain or line 230, secured to the upper ring 210a and at the unseen end of the cable, rope or chain or line 230 to an anchor, a buoy, a larger platform, another apparatus similar or identical to the apparatus 200, etc. Alternatively, the cable, rope or chain or line 230 may be secured to the lower ring 210b instead of the upper ring 210a.

The aquatic plants 240 may be grown on the lower ring 210b by affixing the plants 240 to the lower ring 210b, for example by tying the plants 240 to the lower ring 210b (e.g., using string or rope), binding the plants 240 to the lower ring 210b (e.g., using a polymeric and optionally biodegradable wrap or tape, a zip tie or equivalent binder), etc. Alternatively, when the plants 240 are sufficiently large, they can simply be hung on or wrapped around the lower ring 210b.

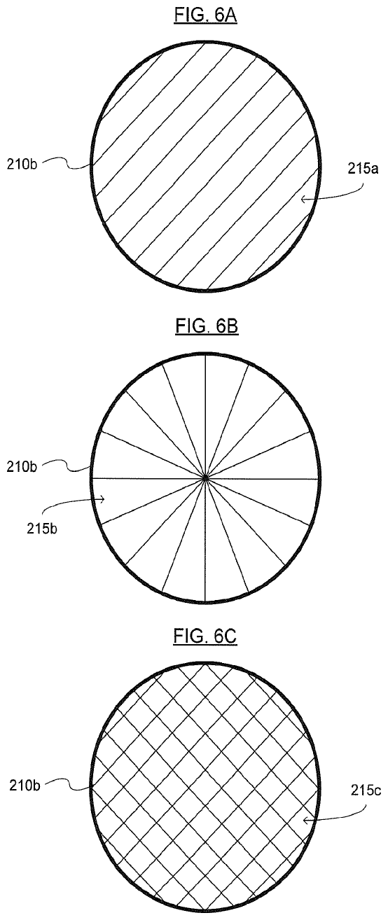

In some embodiments, the lower ring 210b may contain a support to which the plants 240 may be secured or on which the plants 240 may be grown. As shown in FIGS. 6A-C, the support may comprise a plurality of parallel lines or wires 215a (FIG. 6A), a plurality of radially-distributed lines or wires 215b (FIG. 6B), or a mesh or grid 215c (FIG. 6C). The aquatic plants 240 (FIG. 5) may be attached, secured, hung, draped or wrapped around the lines or wires 215 of the support similarly to the direct attachment or affixation of the plants 240 to the lower ring 210b.

FIG. 7 shows an alternative apparatus 300 for growing aquatic plants at a controllable depth. The view in FIG. 7 is a vertical cross-section from the side, through the center of the apparatus 300 in the plane of the drawing page. The apparatus 300 comprises a buoyant upper ring 310a, a submersible (or submerged) lower ring 310b, a plurality of cables or ropes or chains 320a-c, and a plurality of winches 330a-c. A fourth cable or ropes or chain and a fourth winch are not shown.

The cables or ropes or chains 320a-c pass through an opening in the center of the upper ring 310a, and are secured to the lower ring 310b by loops 325a-c. The ends of the cables or ropes or chains 320a-c are secured to the loops 325a-c using fastening devices and/or techniques described herein. To ensure that the cables or ropes or chains 320a-c adequately clear the inner surface of the upper ring 310a, the cables or ropes or chains 320a-c may pass through and/or be suspended above the winches 330a-c by a corresponding plurality of pulleys over the opening in the upper ring 310a, which may be secured to a frame or trellis on and/or affixed to the upper surface of the upper ring 310a.

In use, the winches 330a-c raise and lower the cables or ropes or chains 320a-c concurrently or substantially concurrently. For example, during the daytime, the aquatic plants need sunlight to grow. Accordingly, during good weather, the lower ring 310b is maintained at a depth of about 0.3-25 m, from around dawn to around dusk. At night, the aquatic plants may be lowered to cooler and/or more nutrient-rich water (for example, to a depth of 100-500 m or more, from around dusk or sunset to around dawn or sunrise). The depths to which the lower ring 310b is raised, lowered or maintained may depend on, for example, the width and length (or diameter) of the apparatus 300 or upper ring 310a, the lengths of the cables or ropes or chains 320a-c, the water temperature at various depths, the nutrient profile in the water at various depths, etc. However, generally, the larger the upper ring 310a, the greater the depth(s) of the lower ring.

FIGS. 12A-B are front and side views, respectively, of a manually-operated winch 700, suitable for use in embodiments of the apparatus 300 in FIG. 7. The winch 700 comprises a stand 710, a central axle 715, a spool 730 on which a cable 720 is wound, an arm 740 affixed to and extending perpendicularly from an end of the axle 715, a handle 745 at an opposite end of the arm 740, and a brake or cinching mechanism 750. Winch 700 may also be automatically or remotely operated. The stand 710 is secured to the platform 340 by bolt-and-nut fasteners, for example, but the invention is not limited thereto.

The user grasps the handle 745 and rotates the arm 740 and the axle 715 clockwise to pull in or wind the cable 720 onto the spool 730 and raise the lower ring (not shown in FIGS. 10A-B), or rotates the arm 740 and the axle 715 counterclockwise to let out or unwind the cable 720 from the spool 730 and lower the lower ring. The brake or cinching mechanism 750 is conventional, and may comprise a ratchet or tooth-and-gear mechanism that holds the axle 715 in place while winding, but allows the axle to rotate freely while unwinding. The brake or cinching mechanism 750 may further include a button, lever or other actuator that activates this automatic brake or cinching function while winding, but disengages it while unwinding.

### Exemplary Self-Powered Apparatuses and Structures for Growing Aquatic Plants or Macroalgae at Variable Depths

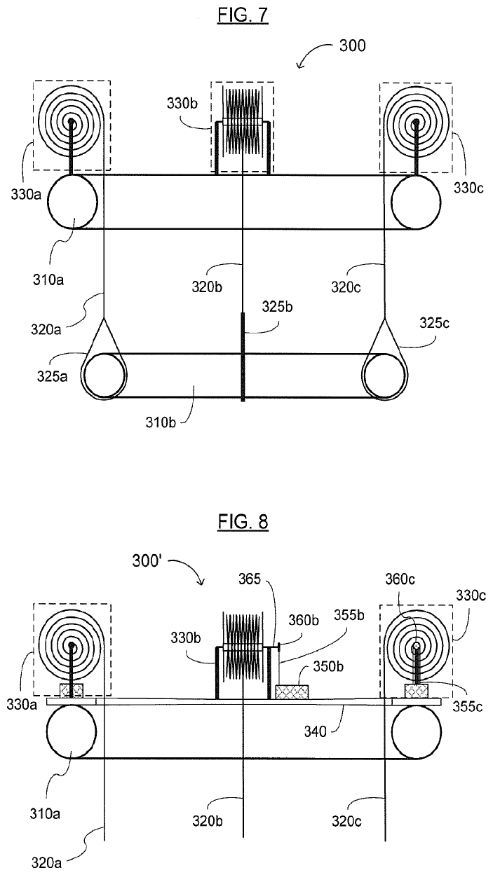

FIG. 8 shows an alternative apparatus 300′, comprising the upper ring 310a, the lower ring (not shown), the cables or ropes or chains 320a-c, the winches 330a-c, and a platform 340. The platform 340 supports the winches 330a-c and motors 350a-c that operate the winches 330a-c. In particular, each of the motors 350a-c drives a corresponding belt 355a-c that, in turn, drives a wheel 360a-c operably connected to the central axle or shaft 365 of the winch 330a-c. The motors 350a-c may also have an on-board power and control system and a wireless receiver, for wireless control of the corresponding winches 330a-c.

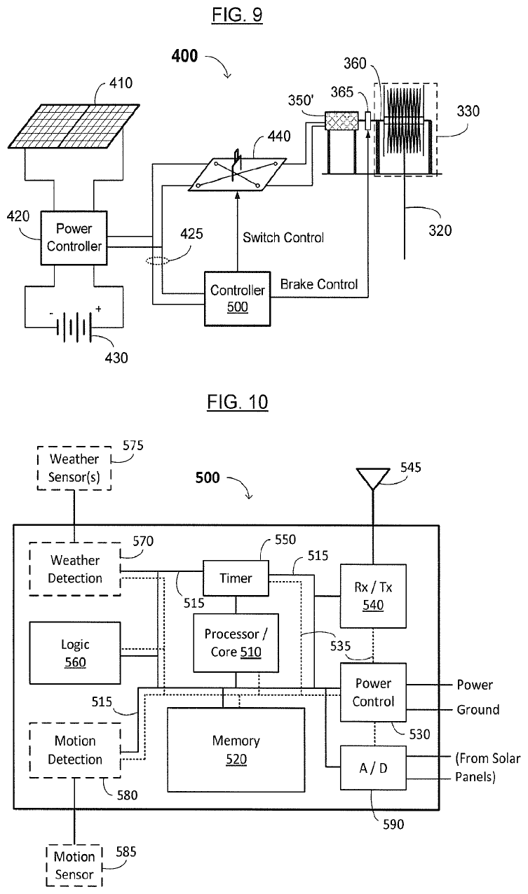

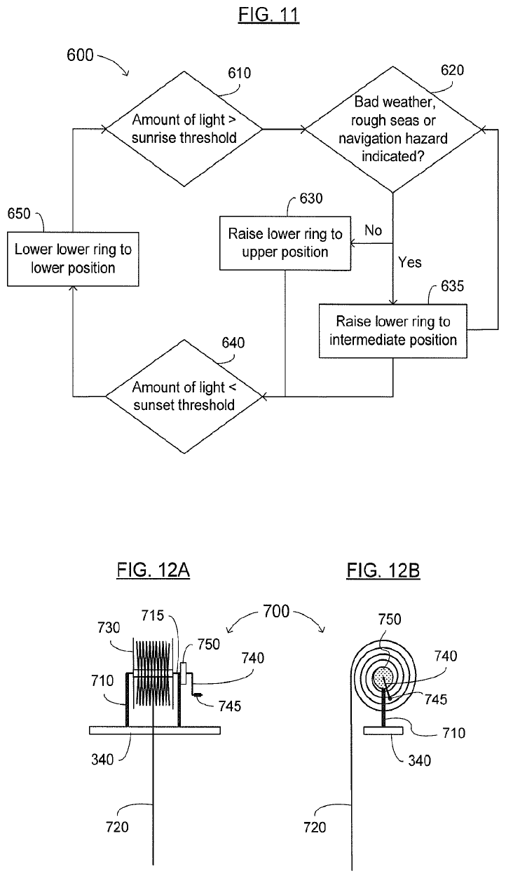

An exemplary on-board power and control system 400 is shown in FIG. 9. The power and control system 400 comprises a green power source 410, a power controller 420, a battery 430, a switch 440, and a function controller 500. The green power source 410 as shown includes one or more solar panels, configured to convert sunlight to electrical energy. Alternatively, the green power source 410 may include a wind turbine, a wave profile device, wave capture device, or other wave energy device that converts wave energy into electricity, etc.

The power controller 420 is configured to provide electrical energy from the green power source 410 to the battery 430 (for storage) and the switch 440 and controller 500 for operation of the winch motor and other electrical devices in the system 300′ (described elsewhere). The power controller 420 is also configured to provide electrical energy from the battery 430 to the switch 440 and controller 500 when the green power source 410 is not producing electricity.

The switch 440 connects electrical power from the power controller to the winch motor 350′ and, if needed, to the brake 365. The switch 440 may comprise a double pole double throw switch, but the invention is not limited to this type of switch. The switch 440 may be controlled (e.g., opened or closed) by a control signal from the controller 500. One or more additional switches may be present to control the supply of electrical power to other devices in the system 300′, and the additional switches may receive an independent control signal from the controller 500.

An exemplary controller 500 is shown in FIG. 10. In its basic configuration, the controller 500 includes a processor or core 510, a memory 520, power control circuitry 530, a receiver/transmitter 540, a timer 550, and function logic 560. The controller 500 may be electrically connected to an antenna 545. The processor 510, memory 520, receiver/transmitter 540 and antenna 545 are conventional. For example, the processor 510 sends instructions to the other components and/or circuit blocks in the controller 500 over internal bus 515, which may comprise one or more serial and/or parallel buses, a plurality of single bit and/or multi-bit buses, a plurality of bidirectional and/or unidirectional busses, a central bus, and/or a plurality of dedicated buses (e.g., between two individual components or circuit blocks). Although the receiver/transmitter 540 and antenna 545 are typically part of a conventional wireless transceiver, wireless communications as contemplated herein include inductive coupling on a conductive (e.g., metal) wire or rope. Such inductive coupling uses radio frequencies and alternating current to couple electromagnetic radiation (i.e., signals) into the wire or rope. The inductively-coupled signals then propagate along the wire or rope, and are received inductively at the receiver. Inductively-coupled signal transmission and reception using a conductive wire or rope is considered herein to be a form of wireless communication.

The memory receives, records, stores and/or provides data, usually in response to one or more instructions from the processor/core 510. For example, the memory may store programming and/or instructions for the processor/core 510 and/or the function logic 560, data from and/or threshold values for the optional weather detection block 570 and/or motion detection block 580, etc.

The power control circuitry 530 may receive power from an external source (e.g., a battery) and may be externally connected to a ground potential. The power control circuitry 530 may provide power to the other circuit blocks over power supply lines 535. The power control circuitry 530 may also connect the external ground potential to a ground plane in the controller 500, wired similarly to the power supply lines 535. In some embodiments, the power control circuitry 530 powers down some or all circuit blocks on the controller 500. For example, the power control circuitry 530 may disconnect the external power from one or more of the processor/core 510, the memory 520, the function logic 560, and/or the optional weather detection and motion detection blocks 570 and 580. Power may be provided to the receiver/transmitter 540 and/or timer 550, except for extreme circumstances, such as a lack of external power, weather and/or motion conditions that put the winch 330 and/or motor 350 at risk of being submerged, etc.

The timer 550 is conventional, and is configured to provide a timing signal to the circuit blocks in the controller 500 that can function in response to the timing signal (e.g., the processor/core 510, the memory 520, the receiver/transmitter 540, and/or the function logic 560). Either the timer 550 or the function logic 560 may include real-time clock logic that provides a real-time clock function. The function logic 560 may be programmed to operate the motor 350 raise or lower the cables or ropes or chains 320 using the winches 330 by predetermined amounts at predetermined times. For example, the function logic 560 may be programmed to raise the lower ring 310b to a relatively shallow depth (e.g., 0.5-25 m) at a time from shortly before, at or after sunrise (e.g., sunrise, plus/minus 10 minutes), and lower the lower ring 310b to a relatively deep depth (e.g., 100-500 m) at a time from shortly before, at or after sunset (e.g., sunset, plus/minus 10 minutes). Given the known or easily determinable relationship between the motor speed and the rate that the cable or ropes or chain 320 travels, one can easily determine how long the motor must operate the pull in or let out a predetermined length of the cable or ropes or chain 320. The function logic 560 can also be programmed to instruct the motor 350 which direction to operate (e.g., a first direction to pull in the cable or ropes or chain 320 and raise the lower ring 310b, or a second, opposite direction to let out the cable or ropes or chain 320 and lower the lower ring 310b).

The optional weather detection and motion detection blocks 570 and 580 may receive sensor data from optional weather and motion sensors 575 and 585, respectively. For example, the weather sensor(s) 575 may include a temperature sensor, a light sensor, a precipitation sensor, a wind sensor, a pressure sensor for sensing hydrostatic depth of one or more rings, a water current sensor (which may sense the velocity or current speed of the water at either the upper ring or the lower ring), etc. Data from one or more of the weather sensors 575 may be compared to one or more corresponding threshold values in the weather detection block 570, and the function logic 560 may provide a signal (or “flag”) to the processor/core 510 to modify the instructions, execute different instructions, or send a different instruction to the motor 350 or other circuit block on the controller 500 (e.g., power control circuitry 530). For example, when the temperature sensor senses a temperature below a first threshold temperature (e.g., 0°) or above a second threshold temperature (e.g., 40°), the light sensor detects an amount of daylight below a first threshold intensity (e.g., 20% of the average daylight intensity for that geographic location on a cloudless day at noon on the winter solstice) or above a second threshold intensity (e.g., 80% of the average daylight intensity for that geographic location on a cloudless day at noon on the summer solstice), the precipitation sensor senses the presence of precipitation, the current sensor (especially at the upper ring) senses a water current above a threshold, and/or the wind sensor senses a wind speed above a first threshold (e.g., 15 m/sec) or a second threshold (e.g., 25 m/sec), the weather detection logic can send a signal to the processor/core 510 that a weather excursion is occurring, indicating that it may not be safe to bring or keep the lower ring 310 near the water surface. Depending on the excursion and/or the number and/or severity of the excursion(s), the processor/core 510 may instruct the motor to pull in or let out a length of the cables or ropes or chains 320 sufficient to raise or lower the lower ring 310b to a depth of, e.g., 25-100 m below the surface.

In one example, a seaweed growing system includes a light sensor 575 and light detector 570 that responds to a threshold light level (e.g., 5% of the average daylight intensity for that geographic location on a cloudless day at noon, on essentially any day or time period), or a timer that is triggered at predetermined times of day (i.e., known times of sunrise and sunset) to cause the controller 500 to send a command to the motor 350 to raise the seaweed shortly before or when it is light (i.e., at sunrise) and lower the seaweed before, during or after sunset, to gain nutrients in lower-lying waters at night. This system may be automated, to avoid any need for human intervention (e.g., twice a day to operate the motor to raise and lower the lower ring, or to manually do so). Alternatively, the light sensor may comprise an analog-to-digital (A/D) converter 590, configured to receive one or more analog inputs from the solar panel(s) 410 and provide a digital output to the light detector 570 and/or logic 560 for comparison with one or more predetermined thresholds.

Similarly, the motion detection block 580 may receive a signal from conventional motion sensor 585 that the upper ring 310a is moving above a predetermined distance (e.g., up and down on waves) or at a rate greater than a predetermined threshold (e.g., >1 m/s laterally, due to current), and the logic and/or circuitry in the motion detection block 580 may send a signal to the processor/core 510 that a motion excursion is occurring, indicating that it may not be safe to bring or keep the lower ring 310b near the water surface, or that action should be taken to prevent the apparatus 300 from drifting too far away from its designated location. Depending on the excursion and/or its severity, the processor/core 510 may instruct the motor to pull in or let out a length of the cables or ropes or chains 320 sufficient to raise or lower the lower ring 310b to a depth of, e.g., 100-500 m below the surface.

Once the functions and operating parameters are known, it is within the level of ordinary skill in the art to design and make the controller 500.

Referring back to FIG. 9, the controller 500 sends a control signal to the switch 440 that, in a first state, closes the switch 440 when power is to be provided to the winch motor 350′ to raise or lower the cable or ropes or chain 320, as described herein. In a second state, the switch control signal opens the switch 440 when power is to be disconnected from the winch motor 350′ (e.g., when the cable or ropes or chain 320 is to be maintained at a certain length, during an emergency or bad weather, etc.). Similarly, the controller 500 sends a control signal to the brake 365 that, in a first state, activates or applies the brake (e.g., in an emergency or bad weather), and in a second state, deactivates or disengages the brake (e.g., under normal operating conditions). Thus, the brake 365 may comprise a so-called “deadman's brake” (e.g., in which the brake is applied when power is disconnected from the motor 350′, or when power is connected and the cable or ropes or chain 320 releases freely or the motor 350′ no longer controls the amount of the cable or ropes or chain 320 let out or pulled in).

### Exemplary Automated Methods for Growing Aquatic Plants or Macroalgae at Variable Depths

FIG. 11 is a flow diagram of an exemplary method 600 conducted by the automated apparatus 300′ of FIG. 8. The method 600 is cyclic and/or continuous, so it can start at essentially any point. However, for sake of convenience, one can start at 610, where the light detector 570 or the logic 560 indicates whether the ambient or environmental light exceeds a predetermined threshold amount or intensity of light corresponding to a typical sunrise. At this point, as a result of action at 650, the lower ring (e.g., 310b in FIG. 7) is at a lower position (e.g., 100-1000 m depth), where the water is cooler and richer in nutrients, but where there is less light. In the case where the logic 560 determines whether the ambient or environmental light exceeds the sunrise threshold, the logic 560 may receive a digital input signal from A/D converter 590 (which in turn receives an analog signal from solar panels 410 corresponding to the amount or intensity of ambient or environmental light) in a comparator for such determination.

When the ambient or environmental light exceeds the sunrise threshold, the control system 400 and/or controller 500 determine at 620 whether any conditions are met that would be dangerous for the plants or macroalgae to come to the surface, such as rough seas, bad weather, one or more navigation hazards (e.g., a ship or other vessel passing nearby), etc. When there are no such conditions, the lower ring is raised to an upper position (e.g., an uppermost depth or level, such as a depth of 1-25 m) at 630 so that the plants or macroalgae can be safely exposed to sunlight. When there are conditions that are dangerous for aquatic plants or macroalgae (or for other vessels on the water), the plants or macroalgae may be brought to an intermediate position (e.g., an intermediate depth or level, such as a depth of 25-100 m) at 635, where the water is safer for the plants or macroalgae, and where they will still receive enough sunlight to survive. For example, it is known that certain species of macroalgae can suffer and even begin to die if they do not receive a sufficient amount of sunlight within a 24-hour period. The method may periodically or continuously re-determine at 620 whether the dangerous or hazardous conditions still exist. If so, the plants or macroalgae may remain at the intermediate position at 635, and if not, the lower ring may be raised to the upper position at 630.

At 640, when the light detector 570 or the logic 560 indicates that the ambient or environmental light has decreased below a predetermined threshold amount or intensity of light corresponding to a typical sunset, the lower ring is lowered to the lower position (e.g., a lowermost depth or level, such as a depth of 100-1000 m) at 650, thereby closing the loop or cycle of the method 600. In some embodiments, when it is safe for the plants or macroalgae to remain at the surface (e.g., the upper position) overnight, the method may count a predetermined number of times (e.g., 2 or 3) that the sunset threshold is crossed at 640 before returning the lower ring to the lower position at 650.

### Additional Apparatuses and Structures for Growing Macroalgae and Aquatic Plants at Variable Depths

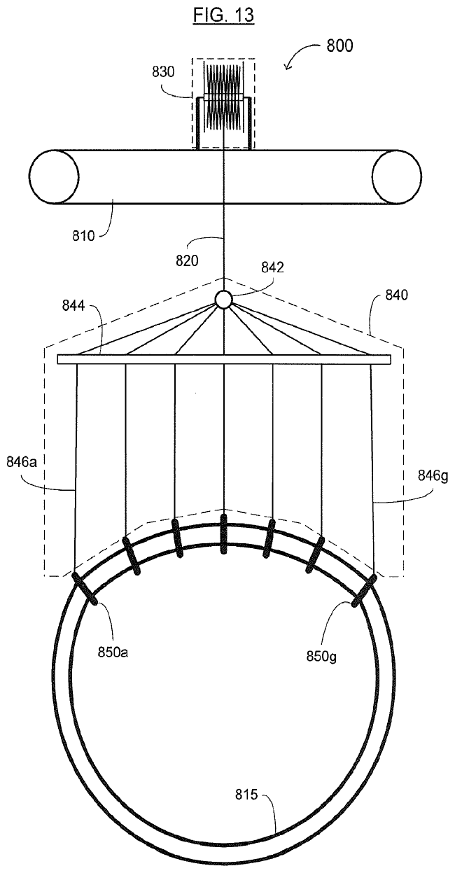

FIG. 13 is a diagram of an alternative apparatus 800 in accordance with one or more further embodiments of the invention. The apparatus 800 comprises an upper ring 810, a lower ring 815, a cable or ropes or chain 820, a winch 830 and a bridle 840. The bridle 840 comprises a spreader ring 842, a spreader bar 844, and a plurality of connecting lines 846a-g. The connecting lines 846a-g are each joined to a corresponding connecting ring 850a-g around the lower ring 815.

The connecting lines 846a-g may pass through the spreader bar 844. For example, the spreader bar 844 may have a number of holes or openings therethrough, and each of the connecting lines 846a-g may pass through a corresponding one of the holes or openings. Alternatively, each of the connecting lines 846a-g may comprise a first line between the spreader ring 842 and the spreader bar 844, and a second line between the spreader bar 844 and the lower ring 815. Each of the first and second lines is conventionally joined to the spreader bar 844.

The apparatus 800 works in substantially the same way as the apparatuses 300 and 300′ in FIGS. 7-8. However, when there is only a single cable or ropes or chain 820, the risk of twisting or tangling plural cables or ropes or chains extending the entire distance between the upper ring and the lower ring (when lowered) is minimized or eliminated. The risk of cable/ropes or chain entanglement or twisting is significant, particularly at aspect ratios >1:1 and/or lower ring depths of >100 m.

Thus, in various embodiments, the apparatus for growing aquatic plants or macroalgae includes only a single winch. The single winch may have a spool with a cable or ropes or chain having a length of 100-3000 m thereon, and the end of the cable or ropes or chain not affixed to the spool may be joined to a bridle. The bridle may include a spreader and a plurality of distributed ropes or lines connected thereto or passing therethrough. The ropes or lines may have a length of 1-10 m between the lower ring and the spreader. In such embodiments, the lower ring may have a width, length or diameter of 10-1200 m, or any value or range of values therein (e.g., 100-500 m).

In further embodiments, the lower ring 815 in the apparatus 800 of FIG. 13 may comprise a fusible material (e.g., a metal such as iron or aluminum, or an alloy thereof [such as steel] that resists damage by salt water; a polymeric material such as PE, polypropylene [PP] or concrete, etc.) that can be passed through the connecting rings 850a-g. In such embodiments, the connecting rings 850a-g may comprise used motorcycle, automobile or truck tires, the lower ring 815 may have a tube diameter or thickness of 0.05-0.60 m, and the connecting ropes or lines 846a-g may be connected or affixed to the motorcycle, automobile or truck tires by any known manner or as described elsewhere herein.

The lower ring 815 may contain a support on which the plants/macroalgae may be grown, for example as shown in FIGS. 6A-C. As shown in FIG. 13, the lower ring 815 may hang in a vertical orientation in the water, but the connecting ropes or lines 846a-g may be distributed in a manner enabling the lower ring 815 to be maintained in a horizontal position. For example, the spreader bar 844 can be a spreader ring, and the connecting ropes or lines 846a-g from the spreader ring 844 can distribute the load (i.e., the lower ring 815 with the aquatic plants/macroalgae thereon) horizontally. Some embodiments of the apparatus 800 can omit the spreader bar 844, and can simply connect the spreader ring 842 (or a pressurized ring) directly to the connecting rings 850a-g (which may be distributed relatively evenly around the lower ring 815) using the connecting lines 846a-g.

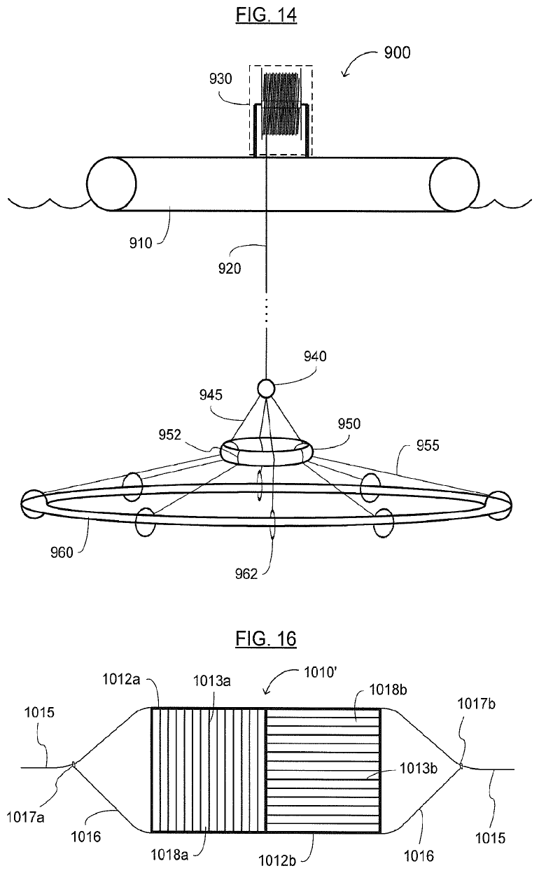

Another alternative apparatus 900 for growing aquatic plants and macroalgae is shown in FIG. 14. The apparatus 900 comprises an upper ring 910, a main cable or ropes or chain 920, a winch 930, a spreader ring 940, an intermediate lower ring 950 and a main lower ring 960. The structure and operation of the apparatus 900 is similar to that of the apparatus 800 in FIG. 13. The components are not drawn to scale. However, in particular, the upper components (i.e., upper ring 910, winch 930) are shown proportionally larger than the lower components (e.g., intermediate lower ring 950, main lower ring 960). For example, the main lower ring 960 can have a diameter or a width and length 5-10 times the corresponding dimension(s) of the upper ring 910 or greater.

The upper ring 910 is similar or identical to upper rings in other exemplary apparatuses disclosed herein, and can operate similarly to a conventional buoy. As with the apparatus 800 in FIG. 13, the apparatus 900 in FIG. 14 has a single main cable or ropes or chain 920 extending from a single winch 930. The main cable or ropes or chain 920 may have a length of from 100 m to 1000 m or longer, depending on the maximum depth to which the lower rings 950 and 960 can go (e.g., to reach cooler water and/or get nutrients). The main cable is connected or secured to the spreader ring 940 as described herein, and connecting lines 945 extend from the spreader ring 940 to the intermediate lower ring 950. In some embodiments, the intermediate lower ring 950 has a central opening and a plurality of connecting rings or loops 952 around cross-sections of the ring 950 to which the connecting lines 945 are secured or connected. In alternative embodiments, the intermediate lower ring 950 comprises or consists of a disc or plate, and the connecting lines 945 are secured or connected to the disc or plate directly (e.g., by passing an end of each connecting lines 945 through the disc or plate, and knotting the end of each connecting line 945 on the other side of the disc or plate). Although four connecting lines 945 are shown, the actual number of connecting lines 945 may be any plural integer (i.e., an integer of 2 or more, such as 3, 5, 6, 8, etc.). In some embodiments, the number of connecting lines is a positive integer by which 360 can be divided to give an integer or a regular fraction (e.g., 3, 4, 5, 6, 8, 9, 10, 12, etc.).

The intermediate lower ring 950 is connected to the main lower ring 960 by a plurality of support lines or wires 955. The support lines or wires 955 may be connected at one end to the connecting rings or loops 952 around the intermediate lower ring 950, and at the other end to similar connecting rings or loops 952 around the main lower ring 960. The support lines or wires 955 generally function as a mechanical support to which the aquatic plants or macroalgae can be attached and on which they can grow. In one embodiment, the lower ring 950 may be ballasted internally or externally to have a net density greater than water, such that it provides ballast to enable the lower ring structure to sink. Such an embodiment may also have the main lower ring 960 comprising a material like HDPE with a net density less than that of water, resulting in net buoyancy. When brought to the surface, such a configuration may result in ring 950 ballasted to remain below the surface buoy 900, while the main lower ring 960 rises to the surface and is kept substantially level by contact with the surface of the water body, thus ensuring good distribution of sunlight across the array when the array is substantially leveled through surface interaction.

As for the connecting lines 945, the number of support lines or wires 955 may be any plural positive integer (i.e., two or more). For example, although eight support lines or wires 955 are shown, the actual number of connecting lines 945 may be any positive integer by which 360 can be divided to give an integer or a regular fraction (e.g., 3, 4, 5, 6, 8, 9, 10, 12, 15, 18, 24, 30, 36 etc.). However, in many embodiments, the number of support lines or wires 955 exceeds the number of connecting lines 945 (e.g., by 2 or more times).

The intermediate lower ring 950 generally has diameter or width and length dimensions much smaller than those of the main lower ring 960. For example, the intermediate lower ring 950 may have a diameter (or a width and/or length) that is 5-20% of the corresponding dimension(s) of the main lower ring 960. However, the intermediate lower ring 950 may have a diameter, a width or a length greater than or less than that of the upper ring 910. Generally, the intermediate lower ring 950 can have a diameter, width or length from about 0.5 to about 2.0 times that of the upper ring 910. Thus, the apparatus 900 in FIG. 14 can be represented by a single buoy (i.e., the upper ring 910) at the surface of the water, a larger intermediate structure 950 below the surface that circumscribes the buoy, and a much larger lower ring 960 that can be joined to the single cable 920 through the intermediate structure 950 using a multi-way cable, rope or chain (e.g., in place of lines or wires 945 and 955) and the connecting ring 940.

FIGS. 15A-B show yet another exemplary apparatus 1000 for growing aquatic plants and macroalgae. The apparatus 1000 is based on a motorized and/or automated rope tow, near the shore or beach 1065 and close to a steep drop-off 1062 to deeper water in the sea or ocean 1050.

The apparatus 1000 comprises a frame or support 1010 on which the aquatic plants or macroalgae grow, first and second plow anchors 1020 and 1025 in the sea floor 1060, first and second buoys 1030 and 1035, and a platform 1100 that controls the depth of the frame or support 1010. The frame or support 1010 may comprise a plurality of sections 1012a-d, and is floating, submerged or partially submerged in the sea or ocean 1050. The first and second buoys 1030 and 1035 are respectively secured (e.g., tied) to the first and second plow anchors 1020 and 1025 by ropes or lines 1032 and 1037. The platform 1100 is secured (e.g., tied) to the first plow anchor 1020 by rope or line 1022. A tow rope 1015 is secured to the frame or support 1010 in at least two locations, and forms a loop around a motorized wheel or pulley 1150 and an underwater wheel or pulley 1040.

The platform 1100 comprises a floating base 1110, a solar panel 1120 or other renewable energy source thereon, a battery 1130 configured to store electricity generated by the solar panel 1120, and an electric motor 1140 that receives electrical power from the solar panel 1120 or battery 1130. The motor 1140 rotates the wheel or pulley 1150 in the clockwise and counterclockwise directions to raise and lower the frame or support 1010. The solar panel 1120, battery 1130 and motor 1140 (as well as any other electrical components on the platform 1100, such as sensors, broadcasting/signal receiving equipment, sonar-based detection equipment, etc.) can be powered and controlled by a control system and controller circuit similar or identical to the system 400 in FIG. 9 or the controller 500 in FIG. 10.

The platform 1100 may raise and lower the frame or support 1010 in accordance with the method 600 in FIG. 11. For example, as shown, around sunrise (e.g., at sunrise, or slightly before or after sunrise), the motor 1140 rotates the wheel or pulley 1150 counterclockwise to pull in the upper section of the tow rope 1015 and raise the frame or support 1010 to the upper depth (e.g., at or near the water surface), as shown in FIG. 15A. If the weather or sea conditions are unsafe for the plants or macroalgae at the surface, then the motor 1140 may raise the frame or support 1010 to an intermediate depth (e.g., about 20-50 m below the water surface). Around sunset (e.g., at sunset, or slightly before or after sunset), the motor 1140 rotates the wheel or pulley 1150 clockwise to pull in the lower section of the tow rope 1015 and lower the frame or support 1010 to the lower depth (e.g., a depth of 500-100 m; about 20-100 m from the sea floor 1060; etc.), as shown in FIG. 15B. If desired, the frame or support 1010 may be lowered to the lower depth every other night, every third night, etc.

The buoys 1030 and 1035 indicate where the plow anchors 1020 and 1025 are, and thus, where the anchor line 1022 and tow line 1015 are, and where the frame or support 1010 is at night. This way, other watercraft and vessels can avoid inadvertently striking or contacting the lines 1015 and 1022 and the frame or support 1010 (and, by virtue of their proximity to the buoys 1030 and 1035, the lines 1032 and 1037). Thus, in some embodiments, the buoys 1030 and 1035 may not be more than a predetermined distance apart (e.g., 1000 m, 500 m, or any other distance at which other seacraft and water vessels can determine the relationship between the buoys 1030 and 1035). In other or further embodiments, the buoys may have the same color and/or pattern, and/or may be equipped with a light (for operation at night) having the same color, or emitting light in the same pattern.

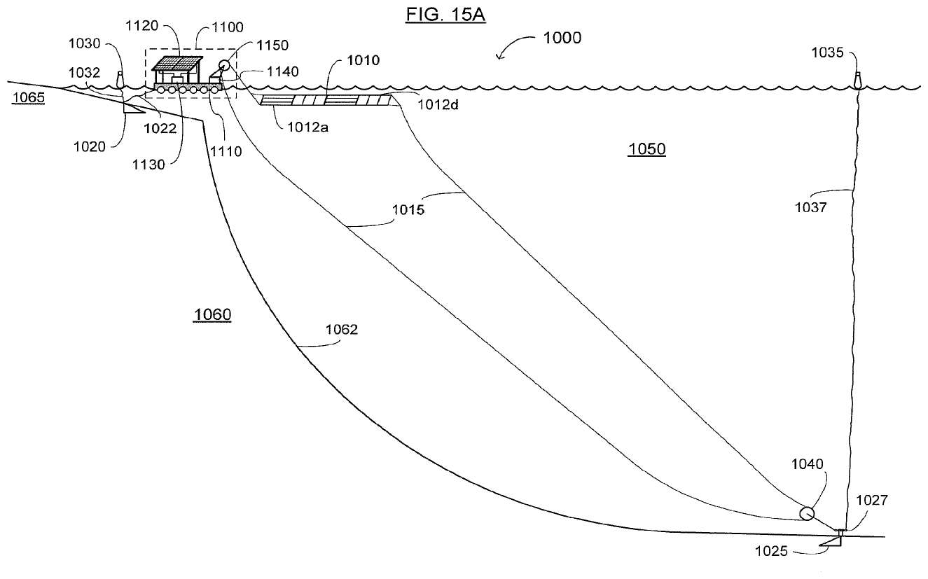

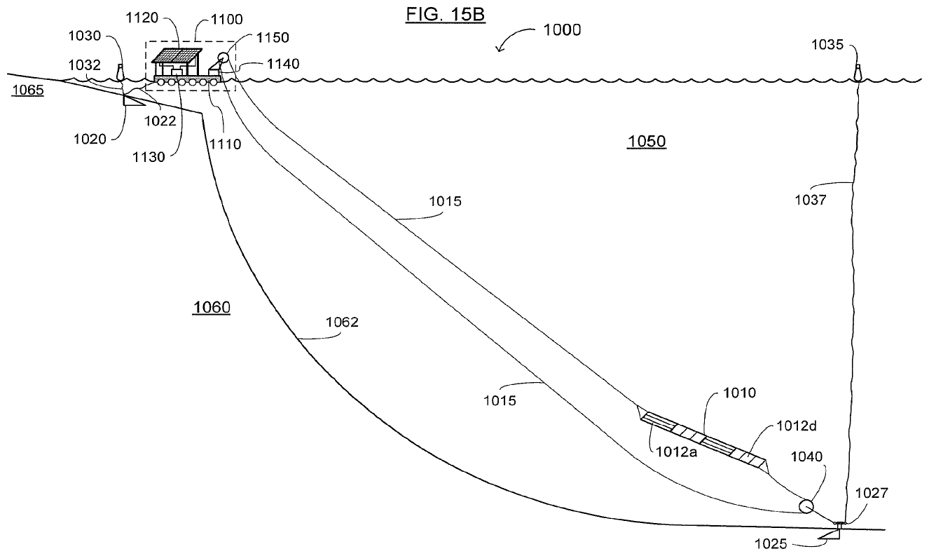

FIG. 16 shows an exemplary frame or support 1010 for use with the apparatus 1000 in FIGS. 15A-B. The frame or support 1010′ in FIG. 16 includes only two sections 1012a-b, but is otherwise similar to or the same as the frame or support 1010 in FIGS. 15A-B. The frames or supports 1010 and 1010′ can comprise any positive integer number of sections (e.g., 1, 2, 3, 4, 5, 6, 8, 10, 12, etc.).

The frame or support 1010′ generally comprises a frame made of a water-insoluble material with a density less than, equal to, or about the same as the density of the water it is in (e.g., sea water, which may have a density of about 1.03 kg/liter). For example, the frame may comprise wood, bamboo, an organic polymeric material, a combination thereof, etc. Each section 1012a-b may comprise a plurality of support rods 1013a-b joined or secured to the frame, which may be equally spaced apart along a width or length of the section 1012a-b, although the invention is not limited to these arrangements. The support rods 1013a-b also generally comprise wood, bamboo, an organic polymeric material, but they may be the same material as or a different material from the frame.

Adjacent support rods 1013a-b define a space 1018a-b for growing plants or macroalgae. In some embodiments, the plants or macroalgae are secured to the support rods 1013a-b directly. In alternative embodiments, the plants or macroalgae are secured to a mesh or net secured between the adjacent support rods 1013a-b, or are placed in a cylindrical mesh or net secured to the support rods 1013a-b and/or frame with a rope or wire that passes or is interweaved through the mesh or net (and optionally at least once around one or both of the adjacent support rods 1013a-b) and tied at each end to the frame. As the plants or macroalgae grow, parts of the plants or macroalgae may pass through the mesh or net, depending on the sizes of the plants or macroalgae and the openings in the mesh or net, and the parts of the plants or macroalgae that remain in the mesh or net can cause the mesh or net to expand in width or diameter. To accommodate this growth, the mesh or net (and the rope or wire securing it to the frame or support 1010′) may have a length greater than the length of the space 1018a-b (e.g., by 1.5-2 times or more).

The tow rope 1015 is secured to the frame or support 1010′ by passing it through eyelets or loops anchored in the frame or support 1010′, passing it through holes or openings in the frame or support 1010′ and knotting or clamping it inside the frame or support 1010′ so that the knot or clamp cannot pass through the hole or opening, etc. As shown, the tow rope 1015 also passes through eyelets, loops or rings 1017a-b at the ends of a secondary rope 1016 that is similarly secured to an opposite side of the frame or support 1010′ from the tow rope 1015, thereby distributing the load and stresses on the frame or support 1010′ when it is raised or lowered.

After the seaweed or aquatic plants are grown to a harvestable size, the seaweed or aquatic plants may be released (untied or otherwise unsecured) from the lower ring (or the mesh or frame thereon) and harvested with a seaweed harvesting apparatus as disclosed in U.S. Prov. Pat. Appl. No. 63/191,433, filed May 21, 2021 (Attorney Docket No. CF-005-PR) or in International Pat. Appl. No. PCT/US2022/______, entitled “Apparatuses, Devices and Methods for Harvesting Seaweed and Aquatic Flora from Large Bodies of Water for Storing and Transporting Seaweed and Aquatic Flora,” and filed contemporaneously with the present application. Optionally, the harvested seaweed or aquatic plants may be processed on a vessel, barge or platform (e.g., deploying the seaweed harvesting apparatus) and packaged (e.g., baled or bundled) as disclosed in U.S. Prov. Pat. Appl. No. 63/191,453, filed May 21, 2021 (Attorney Docket No. CF-006-PR) or in International Pat. Appl. No. PCT/US2022/______, entitled “Apparatuses, Devices and Methods for Harvesting Seaweed and Aquatic Flora from Large Bodies of Water for Storing and Transporting Seaweed and Aquatic Flora,” and filed contemporaneously with the present application. Thereafter, the packaged seaweed or aquatic plants may be towed to deep water (e.g., with a depth >1000 m) if necessary, and sunk in the relatively deep water as a form of carbon sequestration/carbon credits, as disclosed in U.S. Prov. Pat. Appl. No. 63/191,505, filed May 21, 2021 (Attorney Docket No. CF-016-PR) or in International Pat. Appl. No. PCT/US2022/______, claiming priority to U.S. Prov. Pat. Appl. No. 63/191,505 and filed contemporaneously with the present application.

### Exemplary Apparatuses, Structures and Methods for Growing Aquatic Plants or Macroalgae in a Confined Structure Adapted for Facile Seeding and Harvesting

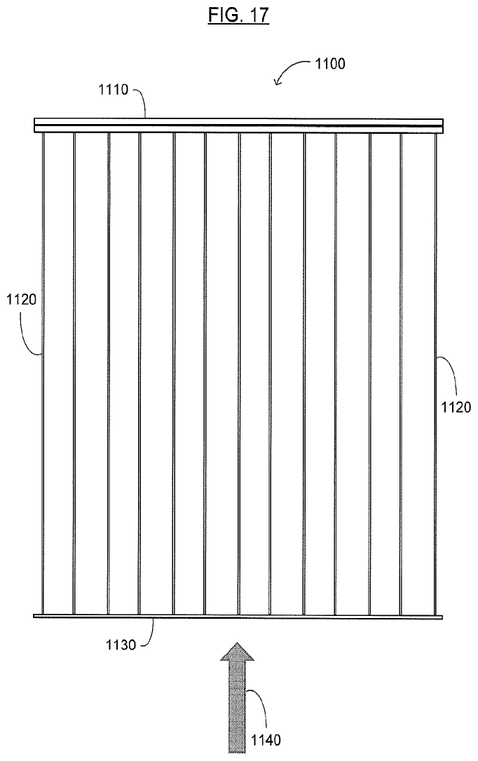

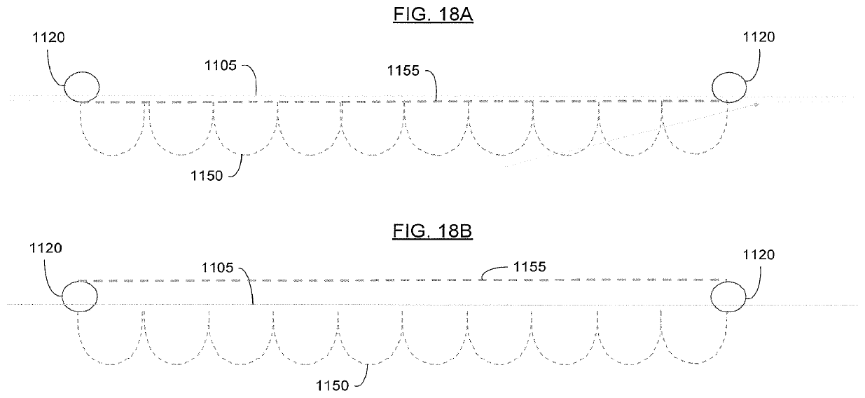

FIG. 17 shows a top view of a further embodiment, including a support structure 1100 for a floating array of marine plants or macroalgae, floating on the ocean surface. The support structure includes a bow pipe 1110, a plurality of ribs (e.g., pipes) 1120, and a stern pipe 1130. The bow pipe 1110 is always floating. In some cases, a double bow pipe may be pre-tensioned, to resist bowing. The ribs 1120 are spaced apart by a predefined distance, such as 2 meters, although the spacing can vary (e.g., from 0.5 to 5 meters). In one example (e.g., for a catamaran), every 5th rib 1120 may be doubled. Further embodiments may include a hydro-foil (e.g., to reduce drag), a water-sail, drag plates (e.g., for steering and tensioning), binding cords to ruggedize the array, and/or seaweed supports (e.g., holdfasts for attaching kelp and other aquatic flora to the pipes 1120 or a tether supported on the ribs 1120). The flora may be raised on plates (e.g., 50 mm×50 mm) to establish them prior to attachment. The holdfasts may be passive (see below).

In one example, the array 1100 is 100 m long×100 m wide. In this example, the bow pipe 1110 comprises two 0.6 m-diameter HDPE pipes with 3 mm walls, the stern pipe 1130 comprises a 0.15 m diameter HDPE pipe having a standard dimension ratio (SDR) of 41, and the ribs 1120 comprise 0.125 diameter HDPE pipes with 2 mm walls. The ribs 1120 and the stern pipe 1130 may be smooth-walled or corrugated. The array 1100 as shown in FIG. 17 contains 60 ribs 1120 total; only 1 of every 5 ribs are shown in the drawing. Such a 100 m long×100 m wide support structure 1100 may contain 3.7 metric tons of HDPE pipes, and may use up to 13 kw-hrs of power (e.g., for propulsion, filling the rib and stern pipes with water, etc.).

The ribs and stern pipe 1120 and 1130 have hollow interiors and share a common volume, and are full of air during the day. It may be useful to pressurize them to a few atmospheres to stiffen the pipes, as long as this maximum pressure does not result in a need to increase the thickness of the pipe wall beyond 1-2 mm (a practical maximum wall thickness for high-yield extrusion manufacturing). The pipe array 1110-1130 is robust against waves and storms, and supports seaweed growing thereon in a manner that promotes a high growth rate, as well as easy seeding and harvesting. The ribs may comprise, for example, pipes, structural members, angles, brackets, and tensile structures such as ropes, tethers, tube nets and netting.

The support structure 1100 (e.g., the “raft”) moves to hold its shape. The arrow 1140 indicates a preferred direction of motion of the raft 1100. Raft movement may be implemented or caused using otter boards and a water-sail.

At night, the rib and stern pipes 1120 and 1130 are flooded (e.g., filled with water). By matching the buoyancy (e.g., density) of the support 1100 to the buoyancy of the seaweed or other aquatic flora thereon, the array 1100 should sink upon flooding the rib and stern pipes 1120 and 1130.

The stern pipe 1130 may be flooded first, and then the ribs 1120, from stern to bow, causing the raft 1100 to sink “stern down,” thereafter assuming a vertical or substantially vertical orientation, suspended by the bow pipe 1110 (which remains floating).

FIG. 18A shows the support structure 1100 with a plurality of tethers 1150. FIG. 18B is an end-on closeup view of two ribs 1120 at a center of the array 1100. The ribs 1120, which may comprise a pipe having an inner diameter of ˜100 mm with a 2 mm thick wall, are floating on the water surface 1105 and are filled with air in the drawing. Each of the tethers 1150 may include a net, a rope, a tensile member, a tube net, a fabric or two-dimensional manifold.

The top part 1155 of the tether is removable for seeding and harvesting (see FIG. 18B). The bottom of the tether 1150 is suspended on tension cords and fixed in place. Each “U” in the tether 1150 may be termed a “hoop-net”. If necessary, ballast may be added to the pipes 1120 or to the bottom of the tether 1150, so the array 1100 can sink when the pipes 1120 are filled with seawater.

Stern and ribs 1120 and 1130 are hollow, welded or bolted together, and filled with either air or seawater. As HDPE has a density of 0.95 g/cc, they float in either case. They support the seaweed-filled tethers 1150, which may be weighted to remain submerged.

The tethers 1150 contain two parts. The bottoms and sides of the tether 1150 are fixed in place and held by horizontal tension cords, one of which is shown here. The top 1155 of the tether is removable and serviceable from a seeding/harvesting catamaran, which travels parallel to the long axis of the ribs 1120. Hoop nets may require some space between the hoops for seaweed penetrating the net material. Creating this space is easily accomplished.

Although seaweed sinks (density approximately 1.04 g/cm³), the tether, if made of HDPE as well, may require small weights (not shown) that keep the tether 1150 submerged below or relative to the surface. If giant kelp is being grown, the spacing and diameter of the ribs 1120 (from which the holdfasts hang) should be increased. Aquatic plants and other flora having a length of 20-25 meters or more should not get tangled as the array 1100 swings from horizontal to vertical. Tube nets are useful for retaining the seaweed, which alternatively may be grown directly on rope stringers as is common practice today or even on irrigation tubing.

The air-filled pipes 1120 and 1130 may be autonomously filled with water and sunk in a controlled manner. Flooding the pipes 1120 and 1130 may be as simple as opening a vent. The bow pipe 1110 is filled with air and sealed, so it always remains at the water surface. The bow end of every rib 1120 may have a small valve that, when opened, allows air to enter or leave. One end of the stern pipe 1130 may have a small electric pump to move water out of the stern-and-rib assembly, while the other end of the stern pipe 1130 has a back-flow-protected vent to allow water to flow into the ribs 1120. To sink the ribs 1120 such that the stern end 1130 sinks first, the stern pipe vent is opened, and the bow-end of all the ribs 1120 vent. The stern of the array starts to sink as water enters at the stern pipe 1130 and pushes air out of the bow-end of the ribs 1120 (which may be held by ropes). When the array 1100 is hanging vertically in the water, all vents are then closed. The weights that overcome the buoyancy of the HDPE ribs 1120 are not shown. They are part of the seaweed support and travel with the ribs 1120. When vertical, the stern of the raft 1100 is at a depth of about 100 m.

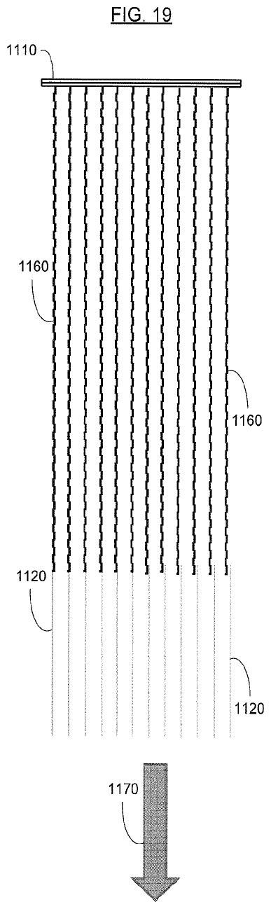

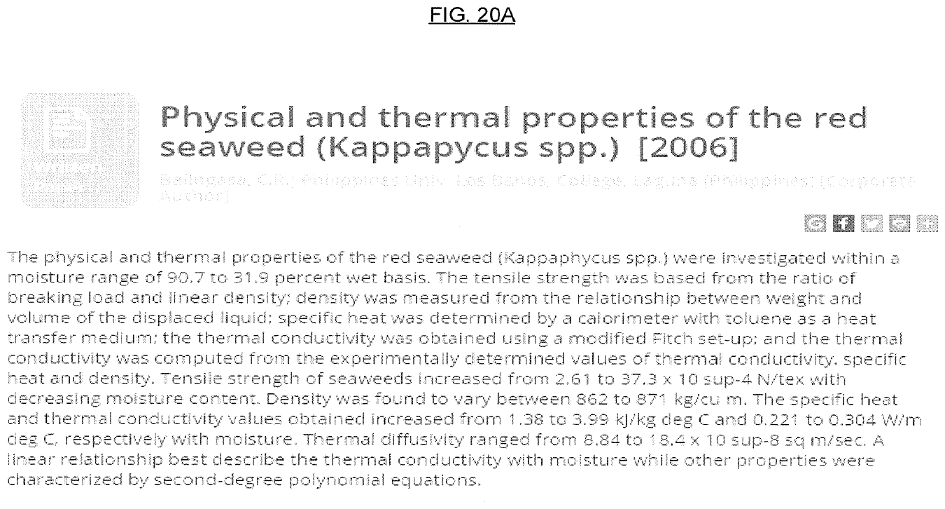

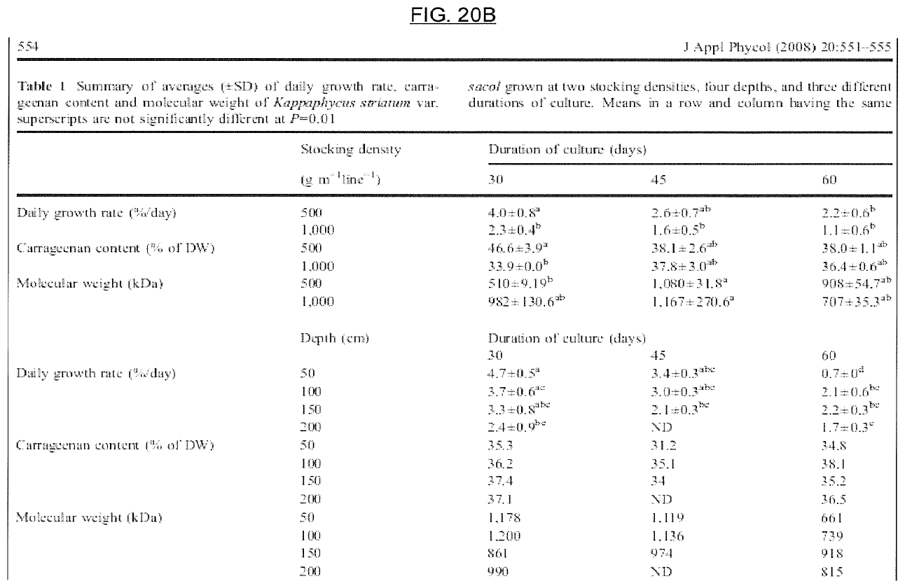

After the array is vertical, it may be further lowered by uncoiling ropes 1160 from the bow pipe 1110 that connect the bow pipe 1110 and ribs 1120, as shown in FIG. 19. The bow pipe 1110 remains floating. If the bow pipe 1110 is 1 meter in diameter, and it is desired to lower the aquatic flora another 200 m, there are 200/π=64 turns of rope 1160 to uncoil. The stern vent is kept open to allow the water pressure inside the pipes 1120 and 1130 to equilibrate. In one embodiment, half of the ropes 1160 are coiled in the opposite direction, so the bow pipe 1110 does not spin as the ribs 1120 are synchronously lowered.

The ropes 1160 may alternatively be uncoiled using an extra heavy weight and a torsion spring (to store the gravitational energy), and then the stored energy can be used to pull the ribs 1120 back up, like a simple roller shade on a window. In another alternative, an electric motor can be used to coil the ropes 1160 onto the bow pipe 1110. A third alternative is a counterbalance and winch, similar to an elevator.

It is not critical for lowering and raising operations to be fast. For example, if it takes an hour to flood the array, an hour to lower the array, an hour to evacuate the array, and an hour to raise the array, there is still about 10 hrs of daylight for growing and 10 hours of nighttime submersion for the plants or macroalgae to store nutrients.

After using a motor, a torsion-spring, or both (or another mechanism) to pull the ribs 1120 back up, the water-filled ribs 1120 and stern pipe 1130 may be inflated to reverse their motion and return to the horizontal position. In its final up position, the bow end of the ribs 1120 are out of the water.

The stern pipe vent is closed, the rib vents are opened, and the electric pump is turned on. For example, the stern pipe vent may be a one-way vent that allows fluid to enter, but not to escape. Each rib 1120 has a small valve that, when opened, allows air to enter or leave. Alternatively, the rib valves may be two separately-controlled one-way valves. Water is pumped out of the stern pipe (bottom), and air is drawn into the ribs 1120. The array 1100 starts to rise, with the stern pipe 1130 floating last, as it is the last to be emptied of water.

When the ribs 1120 are open at the top, the pump may be working against a head pressure. For example, when the ribs 1120 are 100 meters long, this head pressure can be as great as ˜10 atmospheres. In such cases, it may be better to push the water out of one or more of the ribs 1120. Unless the water is pushed out of a center rib, such a push may slightly shift or rotate the array 1100, but the head pressure would drop dramatically as the differences in water density are small. Care should also be taken to ensure that no pipes collapse due to external pressure.

In one example, the macroalgae to be grown on the support structure 1100 may be Kappaphycus, which is nearly the density of seawater (density≈1.04 g/cm³) when growing. Information about Kappaphycus is shown in FIG. 20. Note the density of Kappaphycus shown in FIG. 20 is 1.03 to 1.10 g/cm³. Kappaphycus may grow optimally about 0.5 m below the water surface. Growth may be targeted at a stocking density of 0.5 kg/m/net to 1.0 kg/m/net. The bow pipe may be pressurized (e.g., to the maximum pressure allowed for thin-wall pipes). Two bow pipes may be used to support a multi-drum winch.

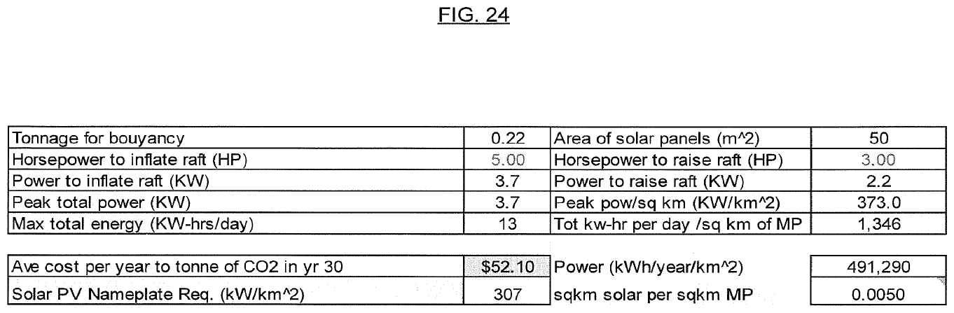

In some embodiments, inflatable spheres may be added to ends of the stern pipe 1130 to prevent collapse of the rib and stern pipes 1120 and 1130. For small rafts 1100 (e.g., having a surface area of about 500 m² or less), such inflatable spheres may not provide such a beneficial effect. In other or further embodiments, a guard ring (e.g., ring 1240, as shown in FIG. 25) may be added to the top of the raft 1100.

In some embodiments, the seeding and/or harvesting may be staggered (i.e., offset) in adjacent rows (e.g., along adjacent ribs 1120) to reduce both crowding and variation in the mass of seaweed. In other or further embodiments, ballast may be added to the tethers 1150. In even further embodiments, one or more spaces (e.g., between ribs 1120) may be formed in the raft 1100 for a seeding and/or harvesting catamaran to travel through the raft 1100. Such a catamaran may be modified to travel over the bow pipe 1110, the stern pipe 1130, and any cross-brace pipes.

In another example, red seaweed is known to have high biomass growth for about the first 32 days. The recommended time to harvest is 45 days. Thus, there are nearly 2 weeks when biomass increase is small. Carrageenan content continues to increase during this period. Consequently, in one embodiment, the start (e.g., timing) of seaweed planting is staggered in adjacent seaweed nets 1150. For example, when the planting of half of the rows (e.g., odd-numbered rows) is 32 days after the other half (e.g., even-numbered rows), then plants are just starting in one set of rows when the adjacent rows have slowed vegetative growth. This interleaving allows good sunlight penetration for young plants, and reduces the variation in the total raft tonnage. Planting in odd-numbered rows may be staggered from planting in even-numbered rows by 22.5 days (i.e., midway through the full growth cycle of red seaweed). Alternatively, two layers of plants may be grown, with plants on the bottom layer being 22.5 days older than plants on the top layer, but this arrangement may be challenging to seed, harvest, and keep submerged at an ideal level.

The more seaweed there is on the raft 1100, as its density is less than that of seawater, the more ballast may be added to the raft 1100 to keep the seaweed submerged. In one embodiment, a partially or fully inflated (air-filled) metal pipe in the bottom of each tether 1150 may be partially filled with sea water (e.g., each day) to offset the daily increase in plant growth. In alternative embodiments, a fixed amount of ballast is added or removed (e.g., to or from those tethers 1150 having a significant change in plant mass). The raft lift comes from inflating the pipes 1120 and 1130, so the lighter the raft 1100 is, the faster (or sooner) it rises. If a slow rise is desired to reduce thermal and/or pressure shock, the water evacuation (and/or its rate) from the pipes 1120 and 1130 should be controlled.

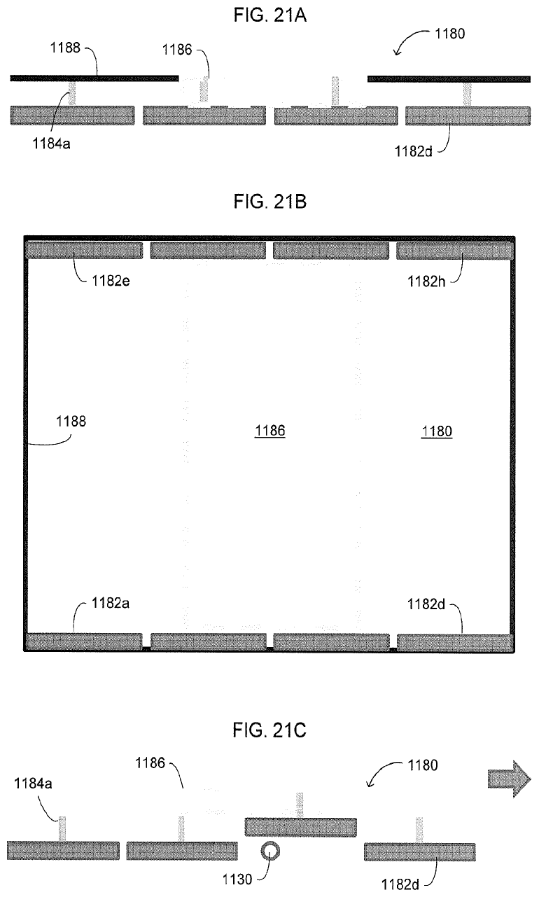

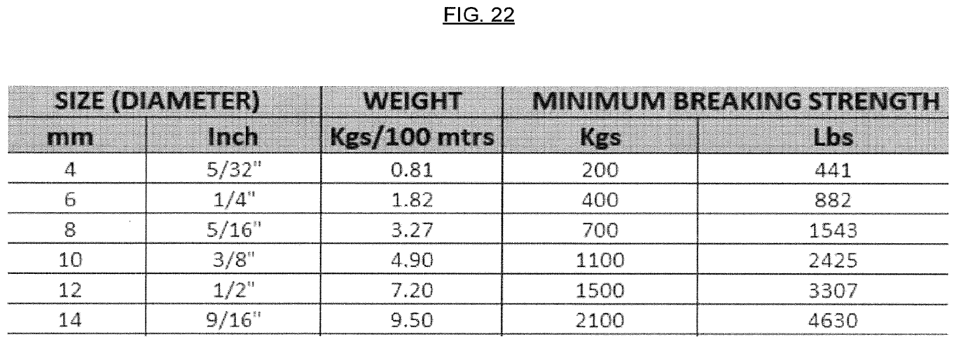

In yet another example shown in FIGS. 21A-C, the seeding/harvesting catamaran 1180 may span 2-5 ribs (e.g., it is 10 meters wide), and the catamaran floats 1182a-h travel in empty lanes (having a width of ˜ 1-3 meters) every 2-5 ribs. The catamaran 1180 may travel over the stern pipe 1130 to the front of the ribs 1120, pulling up the top of the seaweed cover-net 1155 as it goes. Thereafter, the catamaran 1180 may drift back towards the stern pipe 1130, harvesting the mature seaweed while leaving some stock to regrow, and replacing the cover-net 1155 as it moves along. It drifts back over the stern pipe 1130, and then moves laterally to the next set of ribs 1120. Thus, the catamaran 1180 may raise and lower the segments 1182a-h of its multi-segmented floats so as to pass over the stern pipe 1130.

The float segments 1182a-h may be sufficiently vertically displaceable to be lifted over the larger diameter bow pipe 1110 as well. In such embodiments, a series of seaweed rafts 1100 can be sequentially harvested, one after the other, until the last raft in the series is reached. Thereafter, the catamaran 1180 can move to the front of the next set of ribs 1120, and drift back again through the line of rafts, seeding and/or harvesting as it drifts. Of course, the catamaran 1180 can continuously move along the series of rafts 1100 and back, but likely takes more power than moving to the front, either by moving right up the set of adjacent ribs and up and over every bow and stern pipe 1110 and 1130, or just moving around the line of rafts.

Seeding and harvesting take place through a vertically displaceable (e.g., submersible) section 1186 of the catamaran deck (not shown). This vertically displaceable section 1186 can be raised and lowered. Alternatively, the section 1186 of the catamaran deck can simply open up for accessing the water surface, and if desired, another mechanism (e.g., ladders, small platforms, or simple cable, rope or chains) that can be lowered from the deck, but that provides a relatively secure hold or surface from which one can access the surface tether(s) 1155 and other parts of the raft 1100, can be used.

FIGS. 21A-C show an exemplary seeding/harvesting vessel 1180 with two sectioned, retractable floats 1182a-d and 1182e-h. 1184a-h: retractable float pistons; 1182a-h: retractable float sections; 1186: seaweed access area on or through the deck of the vessel 1180; 1188: deck of the vessel 1180.

FIG. 21A shows a starboard view of a catamaran or pontoon boat 1180 that may be, for example, 10 m long×10 m wide. Rods, posts or other mechanisms 1184a-h for raising and lowering the float segments 1182a-h may be pulled up into the deck 1188 and lowered back down onto the water using a conventional device (e.g., a motor, hydraulics, etc.).

FIG. 21B shows a top view of the catamaran or pontoon boat 1180. The floats are divided into sections 1182a-h, each with a rod, post or other mechanism 1184a-h providing the ability to retract the corresponding float section 1182a-h. The submergible or removable section 1186 of the catamaran or pontoon boat 1180 is where the tethers 1150 are accessed and the seaweed is harvested. The seaweed is stored on the deck of the catamaran or pontoon boat 1180. The submergible or removable section 1186 can also be retracted (e.g., raised to deck level) to get over obstacles, such as the stern pipe 1130.

FIG. 21C is a starboard view of the catamaran or pontoon boat 1180 moving over the stern pipe 1130. Float section 1182c is raised via mechanism (piston) 1184c. The seaweed access area 1186 is similarly raised over the stern pipe 1130. The ribs 1120 are not shown.

For a hectare-sized square raft 1100, 100 meters of head (water pressure) must be pumped (e.g., into the stern and ribs 1120 and 1130) when vertical. Thus, an HDPE stern pipe 1130 should have an inner diameter of 150 mm, and preferably SDR 41 (e.g., 3.8 mm wall), so that the pipe 1130 does not collapse when evacuated and still vertical.

On the other hand, the ribs 1120 can be half the diameter of the stern pipe 1130 and have a relatively thin wall (e.g., 2 mm). Ideally, the ribs 1120 can be directly welded into bored holes in the stern pipe 1130.

When the stern and ribs 1120 and 1130 have such dimensions, the total volume of water to be removed is ˜28 m³. The water can be removed in 60 minutes at full head with a 20 HP, 3-phase, 6-stage submersible pump at 71% efficiency. As the raft 1100 starts to become horizontal, the power requirements for the pump drop, and the pump output flow rises. A 15 HP, single phase pump at 76% efficiency may be effective when the raft 1100 becomes substantially horizontal. Ideally, the pump is a direct current (DC) pump.

A 15 HP pump may use 11.2 kW of power at peak, which may consume more power than some relatively affordable portable, green power solutions (e.g., a solar panel for remote use). Increasing the pumping time to 2 hours reduces the flow to 12 m³/hr., allowing use of a 7.5 HP, 8-stage, single-phase pump.

As the stern pipe 1130 is emptied, the raft 1100 starts to move to a horizontal position (e.g., for absorption of sunlight by the aquatic flora). A 5 HP pump can provide 100 m of lift at 20% of the target average flow, but the flow rises to the desired 12 m³/hr. at roughly 60 meters of head. Under such conditions, a 4-stage, 5 HP pump can be used, even though it may work at only 40% efficiency. The 5 HP pump has larger power requirements than a winch, making an arrangement and/or geometry in which water is pushed out of one or more ribs 1120 attractive, reducing the head pressure.

It is beneficial for the ropes 1160 (FIG. 19) to meet certain needs. For a hectare-sized square raft 1100, assuming buoyancy at full plant growth, the maximum weight to be lifted is about 1.5 metric tons (tonnes). An amount of ballast (e.g., in the tethers 1150 or on the stern pipe 1130) to ensure sufficient tension on the ropes 1160 to wind (e.g., around the bow pipe[s] 1110) without twisting is beneficial. Doubling the raft weight with ballast result in a maximum lift of ˜3.0 metric tons, or 50 kg per rope (e.g., for a raft using ˜60 ropes).

From the chart in FIG. 22, a 4 mm diameter rope is sufficient. Spools of 500 m length HDPE rope are widely available. The weight of HDPE ropes 1160 (including guide ribs for seeding/harvesting) at 700 m length is 350 kg, but as the density of HDPE is 0.95, HDPE ropes impose no load on the winch. At sufficiently low rates of lifting, drag forces on the ropes 1160 and raft 1100 can essentially be ignored.

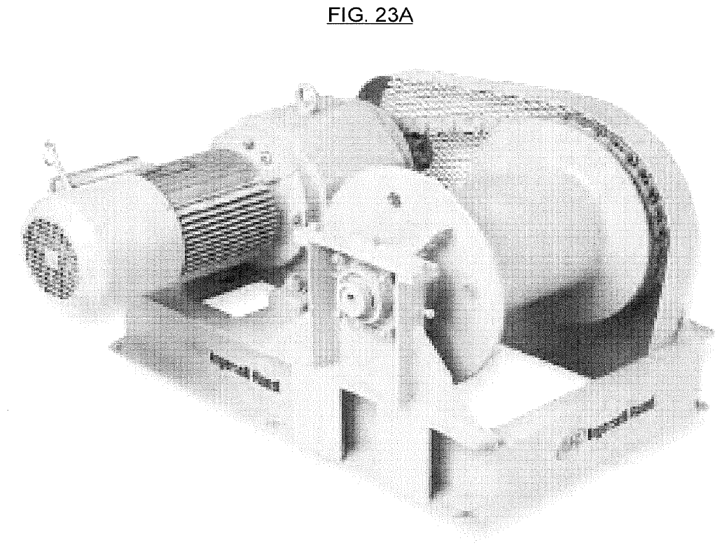

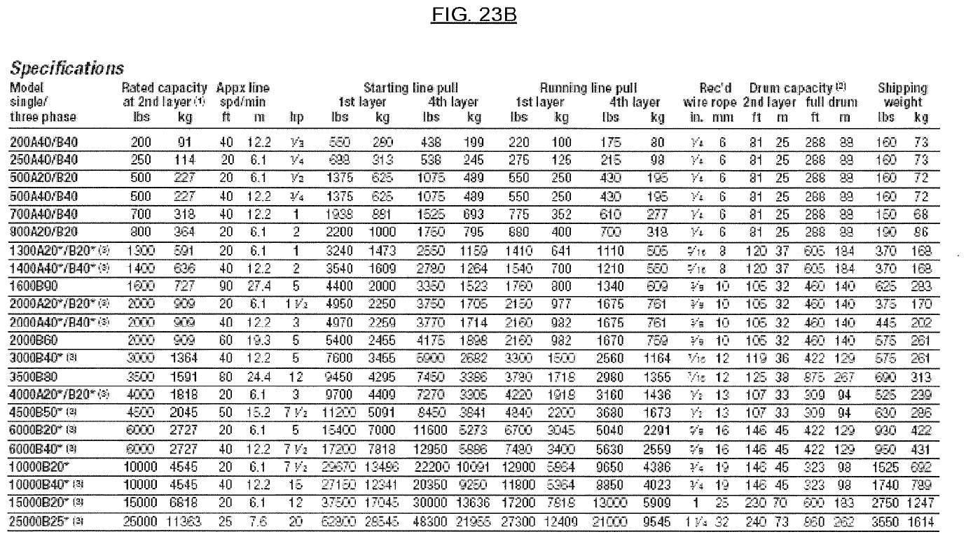

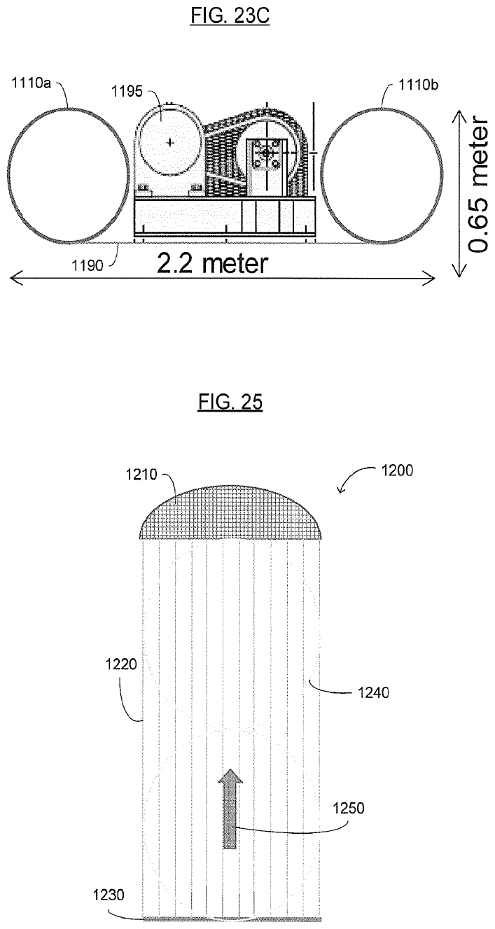

When the maximum weight to lift is ˜3.0 metric tonnes, the ropes must have a minimum static operating strength of 50 kg per line times the dynamic loading factor of 2-8× for dynamic loads under open-ocean conditions for a raft 1100 including 60 ropes 1160. It is important to note that the service operating strength is less than the minimum breaking strength. If the raft 1100 is to be lifted 700 meters in 60 minutes, then the ropes 1160 must be pulled in at a rate of 12 meters/minute. A single drive motor can wind 30 lines onto a rotating set of drums (e.g., supported by the bow pipe 1110), and concurrently wind the other 30 lines on a counter-rotating set of drums. The winch may have a size suitable for the target uptake (pull-in) speed and total load. The drums and gearbox may be customized for a particular application. FIG. 23A shows an exemplary motor for a winch meeting the specifications in the chart in FIG. 23B. The motor may be obtained commercially from Ingersoll Rand (Davidson, NC; Ingersoll Rand may now be known as Trane Technologies).

A 7.5 HP winch can lift about 2.7 metric tons with a 5× safety factor at 12.2 m/s. Such a winch weighs 431 kg with a single spool. When lifting a maximum load of ˜2.0 metric tonnes over the course of two hours, then a 3 HP, single-phase motor can be used for the winch, which cuts the maximum power requirement to 2.2 KW, and reduces the weight to 239 lbs. Such a winch motor benefits from the further inclusion of the torsion spring described herein to lift the raft 1100. On the other hand, a winch with a stronger 5 HP motor, such as that shown in FIG. 23A, can lift 2.7 metric tonnes, which is adequate when used in combination with a 5 HP water pump. The additional HP provides some margin for unexpected drag, friction, and the like, but may require a 3-phase AC power supply.

In embodiments in which the winch drums are not integrated onto the bow pipe 1110, it is possible to support the winch and drums between two bow pipes 1110, as shown in FIG. 23C. FIG. 23C shows an end view of a 5 HP pump 1195 between two 0.6 m diameter bow pipes 1110a-b, on a bounding box 1190 having dimensions of 0.65 m×2.2 m. For example, the catamaran 1180 may need to navigate over the raft 1100 having such a configuration for the winch 1195 and bow pipes 1110a-b. The bounding box 1190 for two 0.6 m diameter bow pipes 1110a-b is 0.6 m×2.2 m, which can support a standard Ingersoll Rand or Trane Technologies model 6000B20 5 HP winch 1195. This size can also fit within the length of the segmented float 1182a-h shown in FIGS. 21A-C (which, for a 10 m-long boat, is 2.5 m long), so the catamaran 1180 should be able to clear the winch 1195 and its support box 1190. Doubling the bow pipe 1110 as described also greatly strengthens it in the direction most needed to oppose seaweed drag, and makes the assembly 1100 more resilient to destructive waves. The double bow pipe 1110a-b also creates a more stable platform as the winch operates. It may be possible to have all drums turning in the same direction, which simplifies the design of the raft 1100.

For an array 1100 having an area of one hectare, the dimensions of the pipes can be optimized. For example, the inner diameter of the double-bow pipe 1110a-b may be determined by (e.g., may match or exceed) the height of the winch 1195. Thus, in our example, each bow pipe 1110a-b may have an inner diameter of 0.6 meter. To keep the mass of the bow pipes 1110a-b low, but allow some overpressure, the walls may have a thickness of 3 mm.

The inner diameter of the stern pipe 1130 may be set by the size (e.g., power, in HP) of the pump that removes water from it. In our example, the inner diameter of the stern pipe 1130 may be 0.15 meter. The stern pipe wall may be determined by the pressure of the seawater on the pipe 1130 when it is empty. When the pressure is that of 100 meters of water, the stern pipe wall may have a thickness of 3.8 mm (at a standard dimension ratio [SDR]=41).

The inner diameter of the ribs 1120 (e.g., when they comprise pipes) may be 50% or less of the diameter of the stern pipe 1130, if the rib pipes 1120 are directly welded to the stern pipe 1130. For example, the inner diameter of the rib pipes 1120 may be 0.075 meter. The rib pipe wall can be a minimum of 2 mm, to withstand the pressure of 100 meters of seawater without collapse. In some embodiments, both the rib pipes 1120 and the stern pipe 1130 can be inflated to 3 bars pressure.

The total tonnage of HDPE pipes having such dimensions in a one-hectare array 1100 is ˜408 tonnes per sq. km. Drag and lift forces on the array during lifting are not expected to be significant, although the addition of one or more hydro-foils to the array may reduce such forces. When the pipes have a relatively small diameter, the hydro-foil(s) may be relatively simple, or omitted altogether.

In embodiments to increase robustness of the array 1100, a water-filled guard-ring (e.g., ring 1240 in FIG. 25) of rib-pipe material may be added. However, the guard-ring may present a challenge for the catamaran to navigate, and it may increase the pipe mass by as much as 6%.

To provide power to the motors for the winch 1195 and the water pump (e.g., 3 HP and 5 HP, respectively, as power source should be provided, preferably one that provides renewable or “green” power. Given that one HP is 0.746 kW, peak power for a 5 HP motor is ˜3.7 kW, and for a 3 HP motor is ˜2.2 KW (see FIG. 24). Assuming the winch 1195 runs for 2 hrs and the pump also runs for 2 hrs each day, power requirements for the motors are shown in FIG. 24. Power should not be necessary to fill the raft's pipes with water, except to open and close the valves.

The present system may require power at night (e.g., to raise the plants to the surface before or at daybreak), but during the plant growth season, often less than the maximum tonnage is being lifted, and the power of the pump throughout the vertical-horizontal transition of the raft 1100 is likely less than its maximum. However, the calculations in FIG. 24 assume application of peak power throughout the entire 4 hours of motor usage. There may be further optimizations, such as storing and reusing the gravitational energy released in sinking the raft, or driving the water in the stern pipe up through one or more of the rib pipes so as to reduce the head pressure.

Some results of the system employing the raft 1100 are surprising. For example, because there is no expensive “lift pipe,” large rafts are not favored. The manner in which the rafts are raised and lowered, and the manner in which the buoyancy of the raft is changed, favor small arrays. However, an array 1100 having an area of one hectare is plausible, although an optimal size for the raft 1100 may be different, especially when using different materials, growing different aquatic flora, and/or implanting a different design/architecture. Furthermore, the technology to raise and lower a raft 1100 are essentially available today, with at most minor modification.

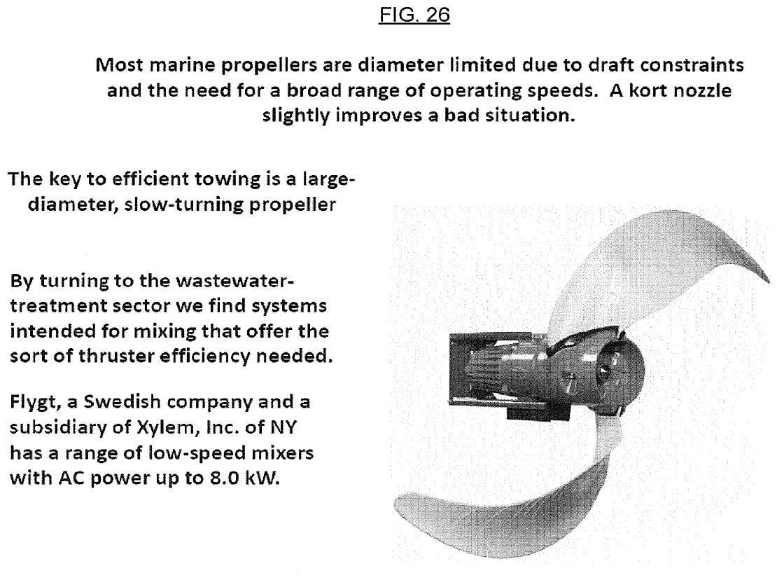

There may be an advantage to propelling the raft 1100 unmoored. Jet propulsion, for example, may enable navigation of certain arrays 1100, by simply directing rib perforations in a certain manner. Alternatively, a bow-mounted, conventional, single hydro-jet solar-powered engine with a rudder may propel the raft 1100, but its efficiency may be relatively low due to the relatively slow speed obtainable using such an engine. A specialized propeller (see, e.g., FIG. 26 and the discussion thereof below) may improve performance and/or efficiency of such an engine.

In such a case, the bow area of a raft/array 1200 may be designed to accommodate a solar array 1210 and engine, as shown in FIG. 25. FIG. 25 is a top view of the raft/array 1200, floating on the water surface, having an area of about one hectare (e.g., 140 m long×70 m wide). The ribs 1220 in the raft/array 1200 are reinforced with one or more guard rings 1240.

Ideally, the raft 1200 may be designed with an aspect ratio (i.e., ratio of the length to the width) to reduce drag and reduce stresses on the bow, ropes and take-up reels (e.g., winch drums), etc. Thus, the ribs 1220 may be longer and fewer in number, and the stern pipe 1230 may be shorter. The arrow 1250 indices the direction of propulsion.

In the raft 1200, water may be driven and/or evacuated from the rib and stern pipes 1220 and 1230 through a rib tube 1220, as it is generally not advantageous to increase the head pressure during a lifting operation. Associated frictional drag may also be analyzed. The plants or seaweed may also benefit from greater variation in nutrients, temperature, etc. during night-time feeding.

An exemplary propeller is shown in FIG. 26. The blades of the propeller shown in FIG. 26 are designed for high-flow, low-head operation, and can generate high thrust at low RPM.

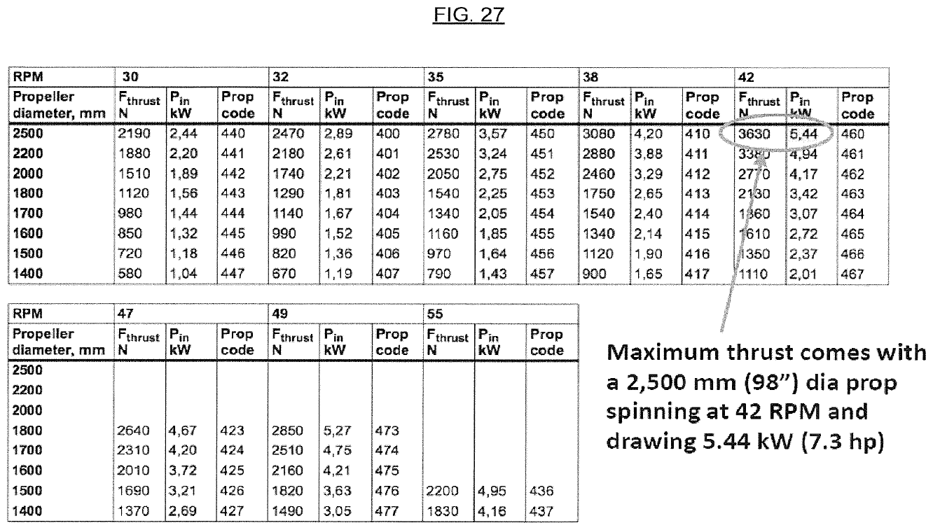

An analysis of the chart in FIG. 27 can determine an optimal propeller and motor to use. There are many choices in the 3-6 HP range, which means that such a propeller and motor can be added to the raft 1200 with a simple doubling of the output of the solar array 1210 (without batteries). When the propeller has a maximum diameter of ˜2 meters and is situated substantially beneath the tethers, its wash (e.g., downstream turbulence) ideally flows beneath the seaweed or other flora in the tethers.

Although an electrical generator and battery can be added to the raft, it may be simpler and more energy-efficient to mechanically store the energy from lowering the raft, and use the mechanically-stored energy to raise the raft in the morning. A spring built into the interior of a winch drum may provide the mechanism to mechanically store such energy.

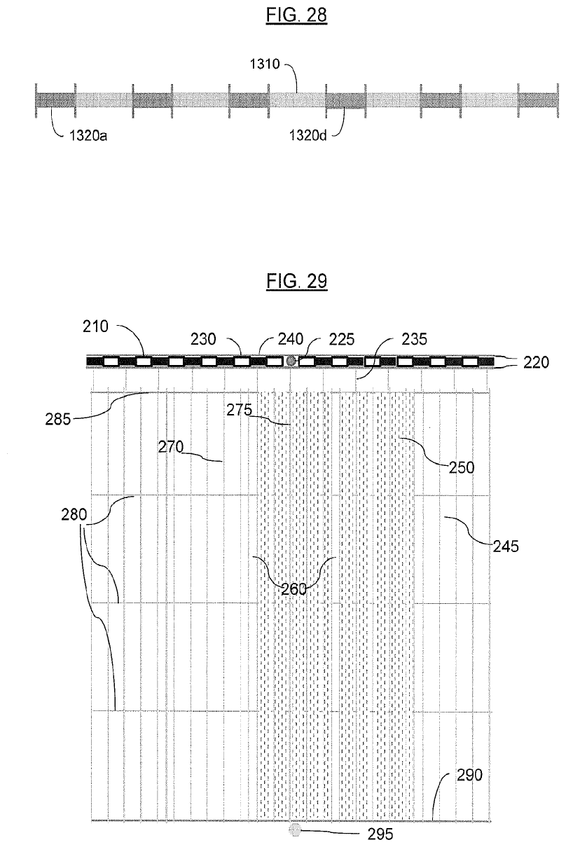

FIG. 28 shows a front view of a section of a bow pipe 1310 of a raft, with 6 take-up reels 1320a-f (each having a width, e.g., of 0.75 meter). The take-up reels 1320a-f may be spaced apart by a predetermined distance (e.g., on 2.0-meter centers).

The spring is ideally of a constant, but selectable, force. For example, a plurality of spring in parallel may be present, and as many as are needed in a given situation can be engaged. The table below includes parameters for a torsion spring design suitable for replacing the 3HP motor in the winch for the hectare-sized example array.

| | Distance (m), time (m) for lift | 700 | 120 |
|---|---|---|---|
| | Lift velocity (m/min, f/min) | 5.8 | 19 |
| | Rope dia(mm)&mass(kg/100 n [symbol] | 4 | 0.81 |
| | Number of ropes, mass (kg) | 72 | 408 |
| | ID of takeup drum (m) | 0.3 | With 0.5 m ID |
| | Width of takup drum (m) | 0.75 | and 2 m width, |
| | Rope length in 1st layer (m) | 177 | can fit rope |
| | Approx number of layers | 4.0 | in 1 layer |
| | Mass to be lifted (kg) | 2,000 | 3 HP is good |
| | Potential energy (MJ) | 14 | match to |
| | Horsepower of winder (HP) | 3.0 | 2 tonne |
| | Energy of winder (MJ) | 16 | load |
| Deflection of coil (deg) in torsion spring | | | 360 |
| | # of turns, # of coils | 743 | 743 |
| | wire dia (mm), coil length (m) [symbol] | 1.0 | 0.74 |
| | length of wire (m), mass (kg) | 700 | 4 |

[symbol]

indicates data missing or illegible when filed

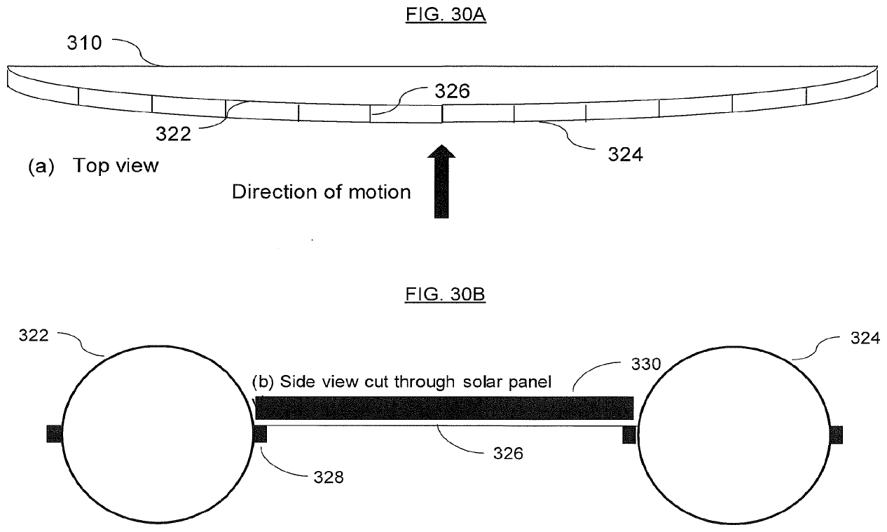

FIG. 29 is a top view of a horizontally-disposed array, floating on the ocean surface. 210: floating bow section; 220: pair of bow pipes; 225: propulsion means; 230: solar array; 235: suspension ropes; 240: multi-rope winder; 245: seaweed frame; 250: netted seaweed; 260: lanes for seeder/harvester; 270: rib pipes; 280, 285: cross members; 290: stern pipe; 295: bias float. The floating structure may have dimensions ranging from 10-300 meters (e.g., having a median area of 0.25-2 hectares). The structure is capable of horizontal movement and acts in many ways like a ship, having a power source 230 (floating solar panels), optional propulsion 225 (e.g., a high-thrust propeller), in one embodiment mounted on the front and center of the floating bow section 210. Also contained is a GPS system for determining location and navigational lights at bow and stern (not shown). The bow section 210 comprises a pair of sealed, air-filled hollow pipes 220 made of a durable, non-corrosive material. A good candidate material is high density polyethylene (HDPE), one of the simplest thermoplastics, from which long pipes of thin cross section can be easily extruded. The material is easily recyclable, and possibly can be made from Kappaphycus itself, rather than from petroleum, as is the current practice. Most pipes in the structure can be relatively thin-walled, with a wall thickness of two millimeters, so that they are pliable enough to conform with modest waves of several meters. Pipes are often described by the dimension ratio (DR), or ratio of the pipe outer diameter to the pipe wall thickness. If a particular DR is commonly used in the industry, it is called a standard DR (SDR). The pipes may comprise SDR 41 pipes and SDR 26 pipes, both of which are commonly available. Smaller DR pipes would be stiffer, even more durable, and can also be used, with a decreased threshold of pipe buckling without pressurization, although the cost of the pipe may increase. As one goal of these seaweed growing platforms is to remove and sequester carbon dioxide from the oceans and atmosphere at very low cost, it is beneficial to minimize the carbon dioxide emitted as part of the construction, use, and recycling of the seaweed growth platform. Minimizing this so-called “embedded carbon footprint” of the structure is an important principle of the present invention. In one embodiment, when a 0.3-meter diameter is selected for the bow pipes, and SDR=41, the wall thickness is 7.7 mm, which is well above the 2.0 mm considered to be adequate for butt-welding of seams, for example, to attach an end-cap to the pipe end to form a hollow, water-tight and gas-tight cylinder. These sealed bow-pipe cylinders may be pressurized by filling with air to approximately 6.0 atmospheric pressure without bursting. Such pressurized pipes have increased rigidity and reduced likelihood of buckling under stress, as is desirable during storm conditions or when opposing drag conditions exerted by the effect of motoring into the current while pulling the filled seaweed nets. At a length of 50 meters, the pair of pipes can support over 7 tonnes of mass. To prevent the pipes from large deflections in the horizontal plane, the two pipes should ideally be connected to each other through a series of spars. As is well known to those in the art, such a dual-beam structure has increased rigidity in the plane of the pair. These spars can then serve as supports for a set of solar panels 230, which serve two purposes. One purpose is to power the propeller unit 225. A second purpose is to inflate the common interior of the assembly of rib pipes 270 and stern pipe 290 that support the seaweed nets 250. The spars may also support a multi-drum electric rope winder 240, which in turn allows the seaweed frame 245 to be raised and lowered in a controlled fashion. To facilitate the attachment of the spars, to provide further support for the devices located between the bow pipes, and to further increase the rigidity of the bow pipes against drag forces, the shape of the bow pipe may be modified to increase the wall thickness in the midplane of the pipe. If additional support is required to keep the bow straight, the dual-pipe structure can be pre-stressed using, for example, ultra-high-density polyethylene (UHDPE) cable to bend the structure in a direction opposed to the drag forces. These cables are in common use today, and exhibit very low change in length under high loads. Properly pre-tensioned to the maximum expected forces trying to bend the bow pair ends downstream, the bow pair may remain slightly concave; that is, with a shape opposite that which is conventionally used for the bow of an ocean vessel.

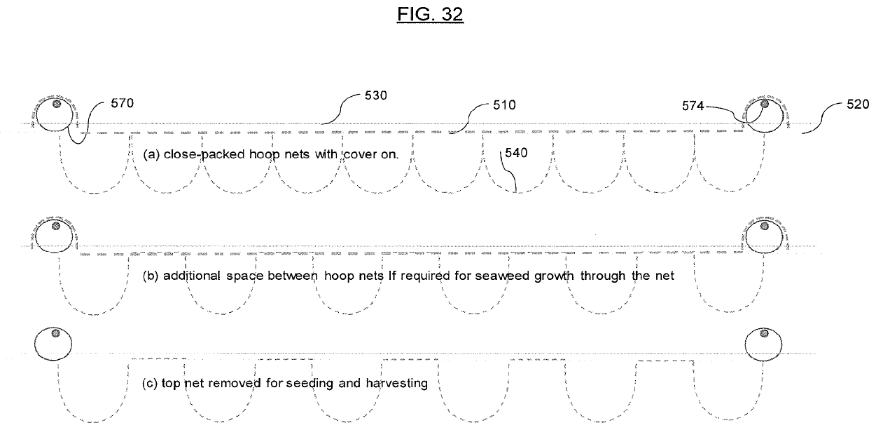

The purpose of the bias float 295 is discussed with regard to FIG. 31A.

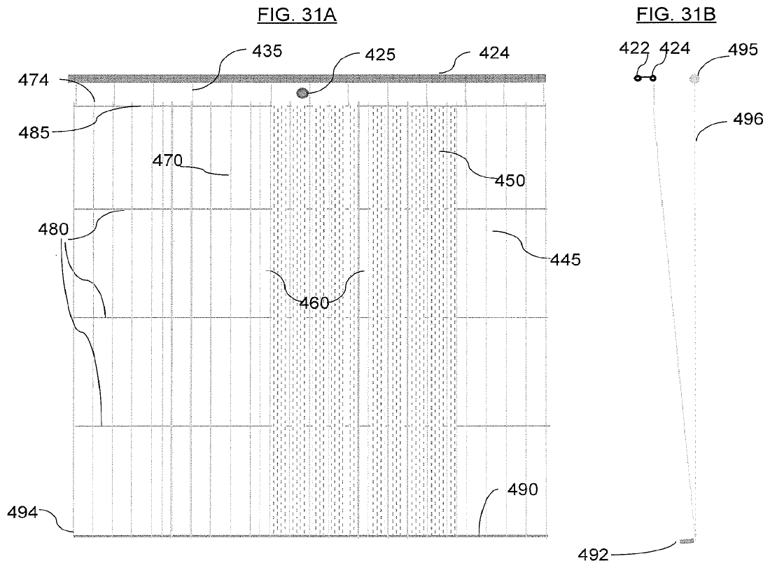

FIGS. 30A-B are closeups of the bow section of FIG. 29, which may also be suitable for the bow section of the raft 1200 in FIG. 25. The forward curve of the bow section has been highly expanded. FIG. 30A is a top view; FIG. 30B is an end view. Element 310 comprises a pre-tensioning cable; 322 comprises a front-most bow pipe; 324 comprises a rear-most bow pipe; 326 comprises supporting spars or textile materials; 328 comprises a thickened section of pipe wall; 330 comprises one or more solar panels.

In the top view, the vertical scale has been highly exaggerated to show the pre-tensioning cable 310. In the side or cut view through solar panel 230 in FIG. 29, the thickened sections 328 of the two bow pipes 322 and 324 are shown along with one of the spars 326. The thickened wall 328 is extruded as part of the pipe. As the cross-section shown in FIG. 31B is through one of the solar panels, the multi-rope winder is not visible. A single rope winder is manufactured by Ingersoll Rand Industrial Technologies. Their model 500A40 has the desired lifting rate and speed, fits in the available area, and is available in marine grade. The envisioned multi-rope winder is similar, with the spindle axis extending the full width of the bow assembly 210 in FIG. 29 and synchronously turning multiple take-up reels, one for each rope 225 in FIG. 29. Each take-up reel is supported on a rigid, marine-grade base and bolted to the top of the extruded section 328, firmly connecting the two bow pipes at many points, greatly increasing the rigidity of the bow section to drag forces in the horizontal plane. The multi-axis rope winder 240 in FIG. 29 is not shown. Although in general, “cord” refers to a thin diameter rope and “cable” refers to a thick diameter rope, the terms cord, rope, and cable are used interchangeably herein. Returning to FIG. 29, the seaweed is contained in nets 250 attached to the rib pipes 270. Nets are a convenient way to contain the seaweed, but the seaweed may also be grown on irrigation tubes or ropes as is common practice for seaweed farming today. During the night, the seaweed is lowered to a depth sufficient to provide nutrition, but the sunk frame 245 with its attached seaweed may be disposed horizontally, vertically, or at some angle in between, or it may assume a non-planar shape. For simplicity, the seaweed frame 245 can be rotated from horizontal to vertical, and then the vertically-disposed seaweed frame can be lowered to a depth for feeding (nutrient supply). The rotation from horizontal to vertical is accomplished by filling the interior cavity of the seaweed array with water while the bow end of the grid is at or very close to the ocean surface. In this way, the pipes of the seaweed array are kept relatively shallow when filled with air, so that compressive forces which could collapse the pipes are minimized. The maximum submerged depth should not be so great as to damage the seaweed. Since an objective of the invention is to ensure that all of the seaweed has access to nutrient-rich water, the embodiment of FIG. 29 favors structures with short rib-pipes. Experimentally, 150-meters depth is sufficient to get good growth rate in some geographies, while 250 meters of depth or more may be beneficial where nutrients are even more abundant. A 50-meter rib-pipe may then have seaweed at the back of the frame feeding at 200 meters, while the seaweed at the front of the frame is feeding at a depth of 150 meters. Further cost savings may be realized with somewhat longer rib pipes, for example doubling their length to 100 meters. Although this dimensioning may benefit from larger pipe wall thicknesses, the area of seaweed grown could be doubled with little change to the rest of the system. All rib pipes 270 share a common air space with the stern pipe 290. That is, the pipes are connected together so that as a unit the interiors of the pipes may be filled with air, so that they float. Thus, the ends of the stern pipe 290 are capped and airtight, the rib pipes 270 are connected to the stern pipe with “t-connections” as are common in the art, and the bow ends of the rib pipes are capped as well. For high strength and ease of recycling of materials, these caps may be made of HDPE as well, and butt-welded to the pipes. For the T-connections, there are several options, including saddle joints with bolted or sanitary flanges, or slip-fittings, either electro-welded or epoxy-glued. Butt joints are made by melting both sides of the materials to be jointed, and then pressing them together as they cool. The slip-joints are similar to the common solvent-bonded slip fittings used by plumbers to make polyvinyl chloride (PVC) pipe connections. A custom-extruded stern pipe may be made with one side of the pipe having a flat edge to which a rib-pipe can be butt-welded. More securely, the rib-pipe may be electro-welded after insertion into a hole bored into the flat edge. The dimensions of the rib pipes in FIG. 29 may be 50 meters in length, 50 mm inner diameter, and 3 mm wall thickness. Such a pipe has a DR of 41, which is a common industrial wall thickness. The pipes should be thick enough to not collapse, even when vertical. After allowing for a deviation from circular cross section by +/−10%, and a variation in thickness of +/−12%, these pipes are estimated to sustain pressures associated with a depth of over 95 meters while filled with air, without collapsing. The dimensions of the stern pipe may be 50 meters in length, 100 mm inner diameter, and 6.3 mm wall section. The SDR of this pipe is also 41. The stern pipe is sized larger than the rib pipe to increase its mechanical strength, as well as reduce friction when the rib-stern assembly is filled with water and needs to be emptied. It also conveniently fits a common submersible water pump, as discussed elsewhere herein. Both pipes can be lowered to a depth of at least 95 meters while filled with air, although in practice they should be full of water by the time they have achieved this depth.

FIG. 31A is a front view and FIG. 31B is a side view of an embodiment of the present raft with a seaweed array vertically hanging from the floating bow section. 422: floating front-most bow pipe; 424: floating rear-most bow pipe; 425: high-thrust propeller; 435: suspension ropes; 445: seaweed frame; 450: netted seaweed; 460: lanes for seeder/harvester; 470: rib pipes; 474: controllable valve for rib pipe; 480, 485: cross members; 490: stern pipe; 492: submersible pump; 494: controllable valve for stern pipe; 495: bias float; 496: bias float rope. After the ribs are assembled to the stern pipe, cross-members 480 and 485 can be strapped beneath the rib pipes. These pipes may be made of the same 50 mm diameter, 3 mm wall thickness HDPE piping as are used for the ribs. They are capped and sealed, and add strength to the rib-stern assembly. They may be pressurized to 9 bars without bursting, thus adding additional rigidity with little additional cost. This overpressure then allows them to be submerged an additional 100 meters if filled with air. Alternatively, they could be capped and filled with water, allowing them to be submerged to far greater depth. Small molded cross-saddles may be inserted at the point where the rib pipes and cross-member pipes touch. These cross-saddles will distribute the load induced on the crossed pipes by the binding straps, and reduce wear on the pipes as the rib-stern assembly undulates with the ocean waves. Cross member 285 provides attachment for the array of ropes 235. These ropes connect the rib-stern frame 245 containing the seaweed to the bow assembly 210, forming a “complete seaweed raft.” The cross-members may not need to be capped, sealed, and pressurized. HDPE commonly has average density of 0.95 grams per cubic centimeter, while seawater typically has a density of 1.03 grams per cubic centimeter. Thus, hollow HDPE pipes will float, whether filled with air or water. As some seaweeds are buoyant, or may not weigh enough to overcome the buoyancy of the rib-stern frame, it may be desirable to leave the cross-members uncapped and filled with seawater, rescuing their rigidity, reducing concern about collapsing them when submerged. Further, to reduce material costs or to reduce the buoyant weight of the raft, interior cross-members 480 may be modified so that they connect only the first few ribs on the starboard (right side of FIG. 29) and port (left side of FIG. 29) side of the raft. This modification may be done because, as shown in FIG. 32, there are additional ropes, termed tension cords, preferably also made of HDPE, which are used to attach netting to the rib pipes. In the studies made so far, the netted Kappaphycus is slightly negatively buoyant and so sinks. Finally, if the raft still will not sink even when completely filled with water, additional ballast can be added. Calculations show that roughly 90 kg of ballast may be needed to achieve neutral buoyancy when the exemplary raft does not sink. Ballast in the form of a solid iron rod accompanying (e.g., place in or secured or fixed to) every rib pipe, a rod of approximately 3 mm diameter, and double that (i.e., 6 mm) for the stern pipe, provides sufficient weight to sink the raft.

FIG. 32 shows three side or edge views of exemplary arrays, positioned horizontally at the surface of the water. 510: top net; 520: tension cord; 530: ocean surface; 540: hoop net; 570: rib pipe; 574: controllable valve for rib pipe. The net is built of two pieces. Each piece, if straightened out and/or flattened, constitutes a rectangular sheet of netting. The top net 510 is simply draped on top of the rib pipes 570, as well as tension cords 520 which are wrapped around each rib pipe and drawn tight, from the rigidized port ribs on the left to the rigidized starboard ribs on the right. Clips (not shown) connect the top net to the tension cords. The tension cords are spaced roughly a meter apart and threaded through the lower net 540. The lower net, if stretched out, is about three times as wide as the upper net. The net is allowed to pucker, so as to form a series of trenches, or hoops, in the region between rib pipes. At the top of FIG. 32 is shown a tight pitch of 10 puckers in the 2 meters between two rib pipes. These resultant 0.2-meter wide trenches are similar to the 0.2-meter diameter cylindrical nets used for the Kappaphycus growth experiments described in the background. In the middle of FIG. 32 is shown a relaxed pitch, with space between the trenches. Finally, as shown at the bottom of FIG. 32, the top net is pulled back, exposing the open trenches for purposes of harvesting and restocking the seaweed. The nets may be replaced with ropes to which young seaweed plants are attached, following common practice in commercial seaweed farms today.

We now discuss how the seaweed frame is rotated from horizontal as shown in FIG. 29 (245), to vertical as shown in FIG. 31A (445). This rotation is easily accomplished by allowing water to enter the common interior of the ribs and stern pipes. Although it is not strictly necessary, stresses on the frame will be reduced if the stern pipe is flooded first, so that it sinks first. The bow end of each rib pipe contains a controllable vent or valve 474 which, when open, allows air to escape and water to enter. The stern pipe also contains one or more of these controllable vents or valves 494. To flood the interior of the rib and stern pipes, all vents are opened. Opening the stern vent or vents first is recommended, ensuring that water enters the stern first. Depending on the size of the vents and the desired speed of flooding, it may be useful to also open one or more of the rib vents 474 to allow air to escape. Some water may enter the ribs, but as the bow ends of the ribs are tethered by their suspension ropes 435, the stern will eventually start to sink. In some embodiments, the valves may comprise one-way valves, so that air only leaves, but water cannot enter valves 474, and water can enter, but air cannot leave, the valves 494, but a second set of valves may be necessary when the water is removed to re-float the seaweed array.

Water enters through stern valve 494, displacing the air which leaves the rib valves 474. Referring to FIG. 32, the rib-valves 574 (also shown as rib-valves 474 in FIG. 31A) are positioned to remain out of the water as the rib-stern frame 445 of FIG. 31A is flooded or raised during the rotation phase. Whether or not the cross-members are filled with air or water, or even if additional ballast needs to be added so that the seaweed array starts to sink stern first, can be determined after the weight of all components is accurately known. To not thermally shock the seaweed, the sinking may take place slowly, over a period of 30 minutes or so. The speed is easily controlled by the size of the orifice hole in the stern valve. As the seaweed will sink faster the more (negatively buoyant) seaweed there is, the orifice may be sized for when the array has just been harvested and reseeded. The difference in rotation time of a raft just before harvest and one just after harvest is not as great as one might expect from seaweed rate alone, because a full raft of seaweed has more drag as it falls through the ocean water. In any event, within 30 minutes or so of opening the valves, the seaweed array 445 may be hanging from its suspension ropes 435 (and 496, as discussed next). Valves can be left open or they can be closed; their position no longer affects the behavior of what follows unless there is trapped air, in which case the valves are best left open. If valves require energy to keep them open, however, then it is likely best to close them once the seaweed platform 445 has stopped rotating.

FIG. 31B shows a key improved embodiment. If the seaweed array were allowed to continue to rotate until it hung completely vertical, then upon refilling the interior of the rib-stern cavity with air, the array could continue its rotation (rather than reverse its rotation) and end up horizontal but upside down. As inspection of FIG. 32 shows, such a development may make it difficult to open the nets for seaweed harvesting. To prevent that situation, a bias float 495 is introduced. This float is also visible at the bottom of FIG. 29 as component 295. There may be multiple bias floats along stern pipe 290, but one centrally located float may suffice. Referring back to FIG. 31B, the bias float is attached to a rope 496, which in turn is attached to the stern pipe at or near the submersible pump 492. The length of this rope may be somewhat less than the length of the rib pipe, so that the rotation of the seaweed array is stopped short of 90 degrees. A further improvement is that the rope 496 is attached to a rope-winder or other means of controlled rope feed on bias float 495, and configured to release the proper length of rope. One simple means to construct the bias float is to use a short section of the dual bow-pipe structure of FIGS. 31A and 31B, containing a single rope winder. Power for this rope winder could be easily obtained from the solar array that powers the multi-rope winder 240 of FIG. 29. Obtaining power in this way ensures that all rope winders operate together.

The system may be implemented without the need for human oversight. A convenient means to determine when the rotation is complete is that the proper length of bias float rope 596 has been pulled from its winder. However, for various reasons, the sensor may fail to indicate that the rotation is complete. As a backup, if valves 474 and 494 require energy to remain open, then a timer may be employed to close them after sufficient time has elapsed to flood the raft.

Rope-winders may be engaged to lower the ropes to the prescribed depth. For a 50-meter rib pipe, and the algae Kappaphycus, one can lower the seaweed approximately 100 meters by unwinding 100 meters of rope from all reels. Again, the lowering may be done slowly, over about 30 minutes, to not thermally shock the seaweed. There, it stays until just before sunrise, whence the multi-reel rope-winder is employed again to slowly raise the seaweed. Suspension ropes 435, as well as bias float rope 496, may be lowered and raised synchronously, using their associated rope winders.

The gravitational potential energy to raise the seaweed array depends on the total weight to be raised, plus any energy losses due to friction, electrical resistance, or drag. Ballast may be arranged, for example, such that the total mass to be raised is 250 kg. The force of 250*9.8=2450 Newtons can be compared with the force exerted by the seaweed as it is raised. The seaweed may be modelled as a rectangular cross-section 50 meters wide by 0.2 meters high, with a drag coefficient of 0.2. If the rope-winder is allowed 17 minutes to pull up 100 meters or rope (or 120 minutes to pull up 700 meters of rope), then the drag force

$$\\ {F}_{D} = \frac{1}{2} ρ {u}^{{}_{} 2} {C}_{D} A$$

is easily computed as 19 Newtons, or less than 1% of the gravitational force. Thus, the drag force can, in effect, be ignored.

After the suspension ropes have been reeled in so that the rib valves 474 are above the ocean surface, the seaweed array can be rotated from vertical to horizontal, reversing the original motion. This rotation may be accomplished by forcing air in at high pressure, driving the water out. However, water ejected from the stern pipe while the seaweed array is vertical is at roughly 5 bar, corresponding to a water depth of 50 meters, requiring considerable air pressure. Alternatively, water may be forced out at 5 atmospheres, letting air in at atmospheric pressure to the shared interior of the rib-stern pipe array, restoring its buoyancy. The figure shows the latter method. The pumping may be accomplished by action of a submersible pump, which pumps the water out of the shared interior of the rib-stern pipe assembly.

As shown in FIG. 31B, the submersible pump 492 is arranged to be at or near the attachment of the bias float rope 496 to the stern pipe 490. The direction of the ejected water is preferably perpendicular to the major plane of the seaweed array and opposite the intended rotation direction. In this manner, the ejected water assists the rotation of the array to reverse the previous rotation, so that the raft returns to its original horizontal position, and not upside down. To prevent water from leaking through the pump, a one-way valve that allows water to flow out of the stern pipe may be located upstream of the pump. This valve is opened along with rib-valves 474, and the pump is turned on. Air enters through the rib-valves to fill the space created by the ejected water.

As the water is ejected, air fills the rib-stern piping from the bow end. The stern pipe will be filled with air last. This staged filling of the array keeps the seaweed array in plane, reducing stress on the piping. Once the seaweed array is horizontal and floating at the surface, which preferably happens at dawn, the nutrients that were stored in the seaweed vacuoles can now be processed via photosynthesis into plant tissue.

An example of such a pump is a 100 mm (4 inch) commander S series submersible water pump, available from Flint and Wallings Corporation. Their models 4F19A15, 4F19S15, and 4F19G15, 1.5 horsepower, 12 stage, stainless steel pump can move at least 12.7 gallons per minute (48 liters per minute) at a discharge pressure of 80 psi, from a depth of 180 feet (55 meters). At this pump rate, the water contained within the interior of the seaweed frame 245 may be ejected in 70 minutes. As the frame reverses its initial rotation, however, the pump returns to the ocean surface, and the water ejection speed rapidly rises to a maximum of 25 gallons per minute, potentially resulting in a smaller size pump, reducing pump cost and pump power. The 1 HP version of this pump has just 9 stages and can move 13.7 gallons per minute at 20 psi from a depth of 180 feet, achieving the same maximum pump rate of 25 gallon per minute at 80 feet.

The sinking of the seaweed raft need not only occur at night. Ocean storms rarely disturb water at a depth of 50 meters. Hence, submerging the array is a convenient way to avoid conditions that otherwise may damage the array at the surface. Thus, the bow area 210 in FIG. 29 contains navigation means that can allow detection of storm conditions, or at least accept a remote command, and to sink the raft. The bow may remain floating, and when storm conditions are detected to have lessened, or when a remote command has been received, the raft can be restored to its horizontal position at the surface. This same navigational system ideally also has an ability to determine whether there are any obstructions before raising the raft.

The seeding and harvesting of Kappaphycus seaweed grown in the covered hoop-nets 540 in FIG. 32 (also shown as component 450 in FIG. 31A and component 250 in FIG. 29) is aided by a vessel designed to contact the water only in the empty lanes 260 in FIG. 29 (also shown as 460 in FIG. 31A) and able to freely travel along those lanes. An example of such a vessel is described herein and shown in FIGS. 21A, 21B, and 21C. The vessel is similar to a pontoon boat, where the two floats are separated by the space between the empty lanes, a distance of 10 meters in FIGS. 29 and 31A. FIG. 21A shows that the floats are segmented into at least 4 sections, so that any one section of the float (on either or both of the starboard and port sides) may be raised, as shown in FIG. 21C, to travel over an obstruction. The implication is that the travel of the float piston 1184a is larger than the tallest obstacle to be traversed. If the obstacle is perpendicular to the travel of the vessel, for example the stern pipe 1130, then float sections on both the port and starboard sides are raised together. It also means that raising any one of the individual floats will not cause the vessel to tip or become unstable.

The nets of FIG. 32 may be replaced by floating ropes, for example also made of HDPE, as is commonly used today by commercial aquaculture and mariculture operations.

The vessel should also have an access port to the netted seaweed, i.e., an opening in the deck, illustrated by a moveable platform 1186, which when lowered allows access to the netted seaweed, so that the nets may be opened and closed to harvest the seaweed and reseed the nets for the next growing season. Parts of the structure that may potentially collide with an obstacle 1130 can be raised, as illustrated in FIG. 21C as item 1186. Ideally, the vessel can travel over most obstructions, from stern pipe 290 of FIG. 29 to bow section 210 of FIG. 29, so that multiple floating rafts of seaweed may be harvested and reseeded serially.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims of any subsequent nonprovisional application that claims priority to the present application and their equivalents.

1. An apparatus for growing aquatic plants or macroalgae at variable depths, comprising:
an upper or floating ring comprising (i) a material having a density less than that of water or (ii) an air-filled ring, bladder, buoy or vessel adapted to float on a surface of a body of water,
a lower or submerged ring ballasted to have a density greater than that of fresh or sea water, and
one or more cables or ropes or chains connecting the lower or submerged ring to the upper or floating ring, wherein:
each of the upper or floating ring and the lower or submerged ring comprises a material as or on its outermost surface that resists damage by water.

2. The apparatus of claim 1, wherein each of the upper or floating ring and the lower or submerged ring independently has a circular, toroidal, oval, square, rectangular, triangular or other regular geometric shape, and either (i) a width and length or (ii) a lateral dimension of from 10 m to 1300 m.

3. The apparatus of claim 1, wherein each of the upper or floating ring and the lower or submerged ring independently comprises polyethylene, rubber, latex, wood, bamboo or polypropylene, and has a tube diameter or thickness of 0.05-5.00 m.

4. The apparatus of claim 1, wherein each of the one or more cables or ropes or chains comprises polypropylene, polyethylene, carbon fiber composite, steel and/or has a length of from 50 m to 3000 m.

5. The apparatus of claim 1, further comprising one or more winches on the upper or floating ring, wherein each of the one or more winches is configured to raise and lower a corresponding one of the one or more cables or ropes or chains.

6. The apparatus of claim 1, wherein at least one of the upper and lower rings has an internal pressure above ambient pressure.

7. A self-powered apparatus for growing aquatic plants or macroalgae with depth cycling, comprising:
a platform,
a floating support to which the platform is affixed, configured to physically support the platform in a body of water,
one or more winches on the platform, to which a corresponding cable or ropes or chain is attached,
one or more motors on the platform, configured to operate the one or more winches, and
a power source on or supported by the platform, the power source providing power directly or indirectly to the one or more motors.

8. The apparatus of claim 7, further comprising a battery and a power controller configured to provide electrical energy (i) from the power source to the battery and (ii) from the battery to the one or more motors.

9. The apparatus of claim 8, further comprising a controller configured to (i) control the one or more motors to raise or lower the corresponding cable or ropes or chain using the one or more winches by predetermined amounts at predetermined times and (ii) control the power controller to provide the electrical energy from the battery to the one or more motors when the power source is not producing electricity.

10. The apparatus of claim 9, further comprising (i) a light sensor configured to provide light data to the controller for comparison with one or more predetermined thresholds, (ii) a weather sensor configured to provide weather data to the controller, (iii) a temperature sensor configured to provide a temperature of the water at the lower ring, (iv) a current meter that can measure a velocity of the water at either of the rings, (v) a motion sensor configured to determine a distance that or a rate at which the upper or floating ring moves, or (vi) a pressure sensor that measures a hydrostatic depth of the either ring.

11. A controller for growing aquatic plants or macroalgae with depth cycling, comprising:
a processor or core configured to send instructions to other components and/or circuit blocks in the controller over an internal bus,
a memory configured to receive, record, store and/or provide data, programming and/or instructions,
power control circuitry configured to receive power from an external source and to provide power to the other components and/or circuit blocks over power supply lines,
a receiver and/or transmitter, the receiver configured to receive external signals, and the transmitter configured to transmit internal information, and
function logic configured to operate a motor to raise or lower one or more cables or ropes or chains on a corresponding one or more winches operably connected to the motor by one or more determined amounts at one or more determined times.

12. The controller of claim 11, further comprising (i) a weather detection block configured to receive weather data from a weather sensor and/or (ii) a motion detection block configured to receive motion data from a motion sensor.

13. A method of growing seaweed and/or aquatic plants, comprising:
determining whether an ambient or environmental light exceeds a first predetermined threshold amount or intensity of light,
when the ambient or environmental light exceeds the first predetermined threshold amount or intensity of light, raising the seaweed and/or the aquatic plants from a first depth in a body of water to a second depth in the body of water depending on whether any conditions are met that would be dangerous for the seaweed and/or the aquatic plants to come to a surface of the body of water, wherein the second depth is shallower than the first depth,
determining whether the ambient or environmental light decreases below a second predetermined threshold amount or intensity of light, and
when the ambient or environmental light decreases below a second predetermined threshold amount or intensity of light, lowering the seaweed and/or the aquatic plants to the first depth.

14. The method of claim 13, wherein:
when no conditions are met that would be dangerous for the seaweed and/or the aquatic plants to come to the surface of the body of water, the second depth is an upper position, and
when one or more conditions are met that would be dangerous for the seaweed and/or the aquatic plants to come to the surface of the body of water, the second depth is an intermediate position, the intermediate position being lower than the upper position.

15. The method of claim 13, wherein the body of water is a lake, bay, inlet, river, gulf, sea or ocean.

16. An apparatus for growing seaweed or aquatic plant(s), comprising:
a bow pipe,
a stern pipe,
a plurality of ribs, each connected to each of the bow pipe and the stern pipe, and
one or more tethers on or fixed to the ribs, wherein each of the one or more tethers are substantially submerged in the water and attached to the seaweed or aquatic plant(s) growing in a volume or space.

17. The apparatus of claim 16, wherein each of the bow pipe, the plurality of ribs, and the stern pipe comprises a hollow polyethylene or polypropylene pipe having a length of at least 10 m.

18. The apparatus of claim 16, further comprising an upper tether on the plurality of ribs, configured to retain the seaweed or aquatic plant(s) in the volume or space.

19. A method of growing and harvesting aquatic plants or seaweed, comprising:
seeding the aquatic plants or seaweed on one or more tethers on a plurality of ribs, each of the ribs being connected to a bow pipe and/or a stern pipe, and the one or more tethers forming a volume or space in which the seaweed or aquatic plants grow.
submerging the one or more tethers and the seaweed or aquatic plants in a body of water,
growing the seaweed or aquatic plants to partially or substantially fill the volume or space, and
harvesting the seaweed or aquatic plants from the one or more tethers using an aquatic vehicle adapted to travel over the one or more tethers, the plurality of ribs, and at least one of the bow pipe and the stern pipe.

20. An aquatic vehicle adapted to seed and/or harvest aquatic plants or macroalgae in a floating and optionally submersible tethers on or fixed to a plurality of ribs, each connected to a bow pipe and a stern pipe, and the net forming a volume or space between adjacent ones of the plurality of ribs for the seaweed or aquatic plants, comprising:
a vessel spanning two or more of the plurality of ribs, and
a plurality of float segments on each of a port side and a starboard side of the vessel, wherein each of the float segments can be raised and lowered so as to pass over at least one of the bow pipe and the stern pipe.

21. The aquatic vehicle of claim 20, comprising a multi-hulled vessel with a deck, the deck having a seaweed access area thereon or therethrough.
